(19) United States
(12) Patent Application Publication
(10) Pub. No.: US 2016/0358235 A1
(43) Pub. Date: Dec. 8, 2016

(54) PROCUREMENT SYSTEMS AND METHODS FOR BUYING GOODS AND/OR SERVICES VIA THE INTERNET

(71) Applicant: Jon David De Langis, Laguna Beach, CA (US)

(72) Inventor: Jon David De Langis, Laguna Beach, CA (US)

(21) Appl. No.: 14/947,846

(22) Filed: Nov. 20, 2015

Related U.S. Application Data
(60) Provisional application No. 62/171,645, filed on Jun. 5, 2015.

(51) Int. Cl. G06Q 30/06

(52) U.S. Cl. CPC G06Q 30/0605

(57) ABSTRACT

Procurement systems and methods are provided for making buying and selling goods and/or services via the internet easier, faster and more efficient. A procurement system allows users to create and customize one or more orders. Each item for goods or services is standardized according to certain rules, then using a standardized item identification, a search is performed against sellers' databases to determine if item is in-stock or services can be performed. Once the search results are returned, the user can customize the display of the information and then place the order and have the items delivered or the services performed. A Request for Proposal (RFP) can be submitted with different criteria which then can be searched by users who can then place a bid on the RFP. The submitter of the RFP can select and accept the best bid.

### CROSS-REFERENCE TO RELATED APPLICATIONS

This application is a non-provisional application of U.S. Provisional Application Ser. No. 62/171,645 filed Jun. 5, 2015, which is incorporated by reference in its entirety herein.

### FIELD OF THE INVENTION

The present invention relates generally to the field of procurement systems and methods, and more specifically to systems and methods for searching for, procuring and ordering groups of items in one or more orders from different sellers over the Internet.

### BACKGROUND OF THE INVENTION

E-commerce on the Internet today is a complicated mess both for buyers and sellers. There are many problems associated with buyers trying to locate desired items on the Internet, and problems for sellers on how their goods are listed and sold on the Internet. Right now, a buyer can easily buy one or more items from a single website. However, what is needed is a complete paradigm shift in the way things are bought and sold on the Internet, making it easier and more user-friendly for buyers to search for multiple goods from many different websites, assemble the goods into multiple orders from different sellers, and then to place each order with different sellers for delivery at select times. For sellers, more efficient systems and methods are needed for listing and selling their goods from a single location.

Using the current search engines to search multiple websites on the Internet for prices of the same item can be a time consuming and complicated, because a buyer has to first find websites that may offer a particular item and then search each of those websites to see if that particular item is available for purchase. A buyer can waste plenty of time searching a website only to determine that the item is not offered through that particular website.

Although there are comparison shopping engines (CSE) currently available on the Internet, such as Google Shopping, Nextag, Price Grabber and Shopping.com for example, CSE websites are typically good for comparing prices and placing an order for one desired item from a large company. There are at least three limitations to CSE websites. First, a buyer is limited only to see prices from sellers who are registered on a particular CSE website. CSE websites are mostly dominated by large e-commerce and retail companies, such as Amazon, Walmart, Best Buy and Target, just to name a few. Typically there is no online presence from small, local retailers who lack adequate resources, technical knowledge and personnel to list their goods on a CSE website. Second, there is no easy way for buyers to enter multiple items into an order or search on a CSE, so that all items in a group are searched for the best price for the group. Third, there is no way for buyers to enter multiple items into different groups of orders having different delivery dates.

Internet searching in a fragmented market is virtually impossible. A fragmented market include sellers who are small local stores, medium-sized stores and independent stores. These local sellers usually lack the proper resources to list their inventory on their own e-commerce website or another website such as Amazon or a CSE website. Internet searching in fragmented markets returns almost no useful information other than the name, location and contact information for a store. The way the Internet is currently structured gives a great advantage to the larger companies who can list their products on multiple websites, edging out smaller, local, or independent retailers. These small local stores usually do not have adequate resources to have an operational e-commerce website so they miss out on sales.

Internet searching is also virtually impossible for a buyer trying to locate a specific unique item, such as a particular antique or a painting or sculpture having a specific characteristic or style. Internet searching returns only links to a gallery, auction house or other website, such as ebay. None of the information being returned helps a buyer locate unique, original items other than to call or visit the gallery.

Next are described three examples of why the Internet is not efficient for buying and selling goods. Suppose in one example a person wanted to buy a pizza on the Internet for home delivery but first wanted to compare the prices before placing an order. The person must first locate different pizza restaurants on the Internet by performing an internet search using an internet search engine, such as Google, Bing or Yahoo, typing in “pizza Laguna Beach” for example. These search engines return a list of links to websites of pizza restaurants. The buyer is forced to go to each website of the different pizza restaurants, and then use the particular nuances of each of those websites to build a pizza and then calculate the cost of pizza with delivery. This takes a lot of time for just comparing prices of pizza from different restaurants before deciding what restaurant to place an order. Plus the buyer may even miss any specials offered by the restaurant for reducing the price being paid. What are needed are systems and methods for helping a buyer obtain prices from different sellers for a single item having specific features or characteristics.

Suppose in a second example that a person wanted to buy a group of items, say an apple tree and a shovel, but wanted to compare prices from different sellers for those items as a group before buying them. Similar to the first example, the person must first perform an internet search to locate nurseries and small and large stores. After getting the listing of nurseries and stores, the buyer would be forced to select each nursery or store, go to each website associated with a particular nursery or store, and then use each website to look for apple trees and shovels, see if those items are in stock, and then calculate the cost of those two items as a group. This is even more time consuming and an inefficient process because not only does a person have to view multiple websites, but the person is forced to search for each particular item on each of the websites before being able to calculate and compare the total price for the group of two items.

In a third example, there is no e-commerce solution today for purchasing a group of multiple items from different websites at the same time. The current e-commerce websites on the Internet are only good for purchasing multiple items from one website. For example, a buyer can place an order consisting of multiple items from a single website, say for example, Amazon or Walmart. But if the buyer wants to compare prices between Amazon and Walmart, there is no efficient system or methodology that allows a buyer to comparison shop between competitors' websites for a group of items.

Procuring construction materials through e-commerce sites for constructing a building (office, house, etc) is impossible today. There is no Internet search engine available today that can search for a group of items for each order or multiple orders from one or more sellers. Even if such an Internet search engine existed, there is no filtering and compilation of the results into useful information for the general contractor.

Under the current Internet, sellers of goods and products are forced to maintain their own e-commerce website and also maintain and participate as a third-party sellers on larger websites, such as Amazon or Ebay for example. Traditionally there is little or no coherence between how goods are listed on their own e-commerce website and as a reseller on other websites. Moreover, if a seller participates in a CSE website, it usually requires a seller to follow strict guidelines and conventions for listing their goods on such CSE website. These different websites are usually not compatible with each other, making it difficult for a seller to maintain their own website and participate as a reseller on a different website or CSE website.

As can be seen from these examples, there is a great need for systems and methods for orders having standards, harmony and coherence in Internet buying and selling, making it easier for buyers to find and compare goods and products of many different sellers.

### SUMMARY OF THE INVENTION

The present invention provides a new paradigm for buying and selling items on the Internet. The present invention comprises e-commerce or internet-based systems and methods for procuring an item, a group of items, or a group of orders having different delivery dates from a variety of sellers, including small and large national stores, who are able to meet select criteria of the buyer.

Using the electronic procurement systems and methods, buyers can take control of costs, maintain project compliance, manage their orders and greatly reduce costs without loss of quality. Suppliers can increase their consumer base, monitor the market, manage products and use powerful search tools to maximize their profits. The procurement systems and methods allow users to attach documents to their orders, such as a non-disclosure agreement and a materials list.

Once a listing or order is complete, it is ready to be searched by suppliers. The procurement system is designed to process these transactions on the website and limit any potential for the users to make deals outside of the platform. For suppliers the procurement system has searching features like category and keyword search. This transformative technology is not limited to one specific industry. This procurement system can be implemented in environments like automotive service, business supplies, and food service. With tons of features, a fully customizable framework and an intuitive backend management system, the procurement system is the perfect solution to taking complete control of procurement.

As a buyer, once an account is created, one can easily submit a new RFP (request for proposal) listing. A new RFP comprises a title, the start and end dates for the listing, a short description that will show up in the search results, and a full description to better explain your requirements. The RFP listing can also include photos and important documents such as a non-disclosure agreement and a materials list.

The RFP alternatively may include a package of separate, pre-defined or free-form templates that allow a user to customize a whole event or series of events, such for example, a wedding or an off-site business meeting. The packages of RFPs enable a user to become in essence a general contractor, arranging for building of components of a complicated project, say for example, a deck on a house, replacing a kitchen or bathroom, adding a garage, or giving a facelift to a garden/lawn. The systems and methods help a user place RFP's all at once or separately over a period of time with notification to the user when the next phase of the project should be RFP-ed.

The procurement system has a powerful geographic search engine, which can search via a starting address and a search radius. This remarkable search tool displays every listing with in a designated search area and can also display them on the map and in a list below the map. Suppliers can also expand their search radius to locate more listings. Suppliers can quickly find listings in their distribution area and if necessary go beyond their usual boundaries. Buyers will choose a location for their listing, which will show on a map as a pin. Suppliers can watch a listing, place a bid, and message the buyer. They can also download the materials list or nondisclosure agreement and then upload them after they have been completed and signed.

Suppliers can make their choice and view all of listings in that category. They can also narrow down their search by using specific keywords and other options here. Suppliers can quickly find listings in their distribution area and if necessary go beyond their usual boundaries. Suppliers can also expand their search radius to locate more listings.

One object of the present invention is to provide systems and methods for entering a group of items or goods into one or more orders, and for moving items from one order to another order. Another object of the present invention is to provide systems and methods for searching the Internet at the same time for a group of items in one or more orders. Yet another object of the present invention is to provide systems and methods for searching the Internet at the same time for a group of items associated with different orders.

Another object of the present invention is to provide systems and methods for searching the Internet for items from local sellers who are not necessarily associated with large internet companies, or to search for items based on a list of preferred sellers or to search for items based certain criteria from the buyer. Yet another object of the present invention is to provide systems and methods for filtering the Internet search results to eliminate sellers who fail to meet certain criteria. Another object of the present invention is to provide systems and methods for compiling the filtered Internet search results and storing the results for a certain time period.

Yet another object of the present invention is to provide systems and methods for displaying the search results according to a buyer's preference and having interactive features, including voice interaction, to alter how the items are displayed. Another object of the present invention is to provide systems and methods for moving items in an order associated with a seller to a different order associated with a different seller and then automatically updating each of the orders including total price. Yet another object of the present invention is to provide systems and methods for placing orders at select times, where the orders may have different delivery dates.

Another object of the present invention is to provide systems and methods for creating, providing, and maintaining a seller's inventory of items in a single location. Yet another object of the present invention is to provide systems and methods for making a seller's inventory accessible to internet search engines. Another object of the present invention is to provide systems and methods for making requests for proposal (RFPs) to sellers having certain constraints.

The present invention is a computer-implemented method for procuring items in an order comprising receiving a list of items in at least one order, searching for at least one seller who is able to supply the list of items in the at least one order, searching resources associated with each of the at least one seller for information related to each item in the list, assembling information about the list of items by each of the at least one seller; and displaying the assembled information, where the information associated with each of the at least one seller is separated from another seller.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed and not to limit it.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A illustrates a block diagram of network environment in which a procurement system provides procurement services to client devices via network according to an embodiment of the present invention.

FIG. 1B illustrates a block diagram of a procurement system according to an embodiment of the present invention.

FIGS. 2A, 2B, 2C and 2D illustrate a process of a user (buyer or seller) who uses a device to access the services offered by procurement system according to an embodiment of the present invention.

FIGS. 3A-3B show screens for placing orders according to an embodiment of the present invention.

FIGS. 4A-4B show order screens according to an embodiment of the present invention.

FIGS. 5A-5B show order screens according to an embodiment of the present invention.

FIG. 6 shows information related to a request for proposal according to an embodiment of the present invention.

FIG. 7 shows an example of a screen display of bids associated with an RFP according to an embodiment of the present invention.

FIG. 8 shows an example of a geographical screen display associated with open RFPs according to an embodiment of the present invention.

FIG. 9 shows an example of a screen display for bidding on an open RFP according to an embodiment of the present invention.

### DETAILED DESCRIPTION OF THE PREFERRED EMBODIMENT

Reference will now be made in detail to the preferred embodiments of the present invention, examples of which are illustrated in the accompanying drawings. “Seller” in this application is a broad term to refer to anyone or any business that sells items, goods, products to buyers (including people and entities). The word seller is also synonymous with the following: a supplier, dealer, provider, trader, merchant, manufacturer, store, business, and distributor. Examples of sellers include restaurants, department stores, mom & pop stores, clothing stores, warehouse stores, gas stations, just to name a few of the many types and varieties of different sellers. A “buyer” is a person or entity that is buying items, goods, and products from one or more sellers. A buyer also can be a purchaser, consumer, shopper, customer and a contractor, for example.

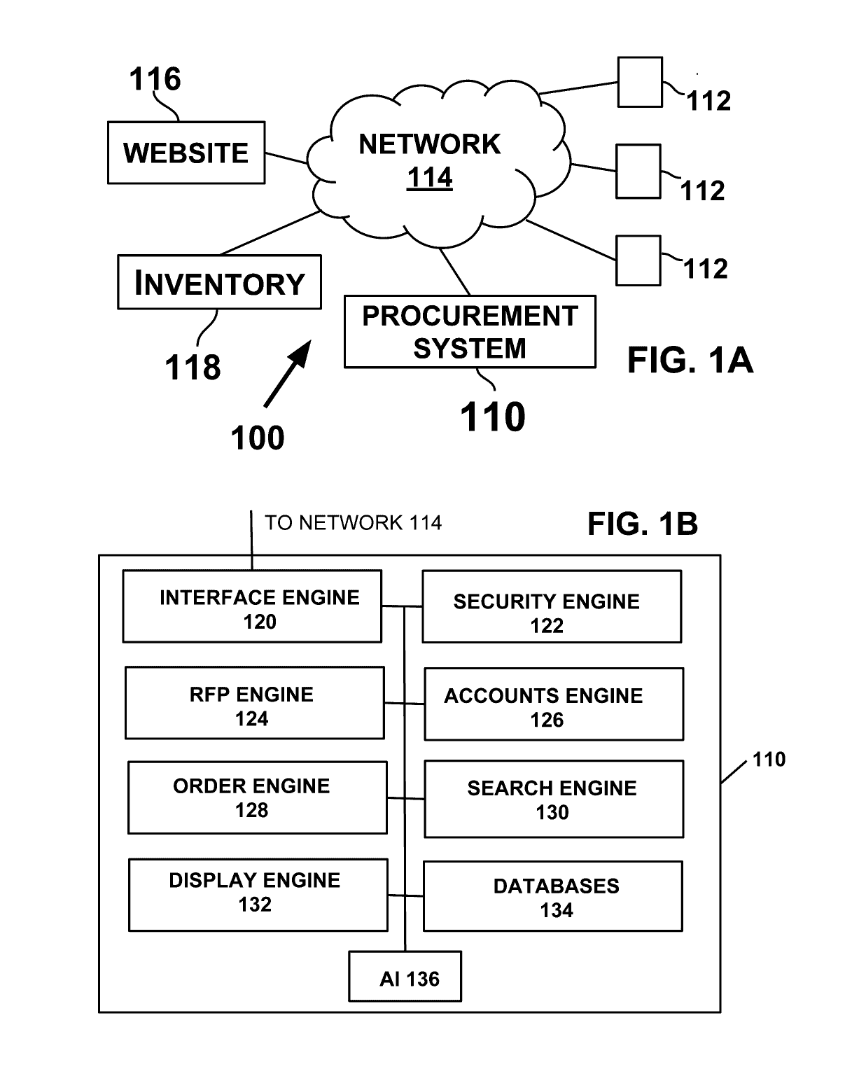

FIG. 1A illustrates a block diagram of network environment 100 in which a procurement system 110 provides procurement services to devices 112 via network 114 according to an embodiment of the present invention. Procurement system 110 is not limited to a single server and may comprise thousands of servers and/or computers connected to the network 114, or to one another, or to groups of servers/computers in one or more locations around the world. Procurement system 110 provides the systems and methods of the present invention. Alternatively, the systems and methods associated with procurement system 110 may also reside on each of the devices 112.

A device 112 can be any type of an electronic device that is under the control of a user and capable of requesting and receiving data over the network 114. Examples of the client devices 112 include servers, personal computers, mobile communication devices (e.g., phones, tablets, laptops, etc.), and any other type of device that can send and receive data over the network 114. Device 112 typically includes many different web browsers and user applications for facilitating the sending and receiving of data over the network 114. Device 112 usually includes at least one processor and a memory unit or device for storing all types of software, including the operating system, applications, data related to the applications, and data related to services provided by the applications.

A computer network 114, such as a local area network (“LAN”), wide area network (“WAN”), the Internet, any other type of communications systems (satellite, telecommunications, 4G LTE), or a combination thereof, connects together procurement system 110, devices 112, websites 116 and inventory servers 118. Network environment 100 may include millions of websites 116, millions of devices 112 and millions of inventory servers 118.

Each of the millions of websites 116 comprises one or more web page resources associated with a domain name. Each website 116 can be hosted by one or more servers, or can be grouped with other websites 116 by the company which helps a user create it, for example Web.com. An example of a web site can include a collection of web pages formatted in hypertext markup language, “HTML,” that also may contain e-commerce information, text, graphic images, multimedia content, and programming elements, such as scripts.

Inventory devices 118 can be any type of device for storing inventory related to a company or business. Examples of the inventory devices 118 include servers, personal computers, mobile communication devices, and any other type of device that can send and receive data over the network 114 related to the inventory of a business or store. There are millions of inventory devices 118 on the network 114.

FIG. 1B illustrates a block diagram of a procurement system 110 according to an embodiment of the present invention. As shown in FIG. 1B, procurement system 110 comprises an interface engine 120, a security engine 122, an RFP engine 124, an accounts engine 126, an order engine 128, a search engine 130, a display engine 132 databases 134 and an artificial intelligence engine 136. Each engine can be referred to as a module, system, computer, server, unit or a combination of these. Each of the engines is connected to each other internally. Each engine may be one or more computers and/or servers, whether remote or local. The procurement system 110 may have multiple systems/servers remotely connected to each other via network 114, meaning that all parts of the engine do not have to be local to each other. The functions performed by one engine can be combined with the functions performed by another engine, or there may be overlap between the functions performed by some or all of the engines.

The interface engine 120 is responsible for customer interaction with users, buyers, and/or sellers. The interface engine 120 communicates with the other engines in procurement system 110 and routes the data and interactions to/from the users. The interface engine 120 may comprise numerous connections to the network 114. Each device 112 may also have a customer engine (not shown) for communicating back and forth with the interface engine 120 of procurement system 110. The interface engine 120 is complex because it requires procurement system 110 to know what type of device 112 is (for example, cell phone, tablet, computer, etc.) and the type of operating system for efficient interaction with that device. The interface engine 120 encompasses all the user interaction processes described in more detail below.

The security engine 122 is responsible for ensuring the communications being received do not contain viruses, bugs or other nefarious computer issues. The security engine 122 is similar to a firewall, which may be built into the server or computer itself. The security engine 122 encompasses all the security processes and aspects described in more detail below.

The RFP engine 124 is responsible for all managing all aspects of helping users submit, search for, and place RFP orders. The RFP engine 124 encompasses all the RFP processes described in more detail below.

The accounts engine 126 is responsible for creating, maintaining and eliminating user accounts, for tracking past and current orders, including whether the order is pending, shipped, in transit or delivered. The accounts engine 126 encompasses all the user account processes described in more detail below.

The order engine 128 is responsible for helping numerous, simultaneous users to create one or more orders, finding standardized item information for each item in order, customizing each order with sellers and locations and placing one or more orders all at once or according to a user-specified timeline. The order engine 128 encompasses all the order processes described in more detail below.

The search engine 130 is responsible for helping the order engine 128 and the RFP engine 124 is locating sellers of specific products or locating RFPs within a certain, user-specified geographical radius. The search engine 130 encompasses all the search processes described in more detail below.

The display engine 132 takes the numerous search results from 130 and compiles the information into user-friendly or user-specific information based on the types of device being used by a user. The display engine 132 works closely with databases 134 to update and keep track of in-stock items and services of sellers. The display engine 132 encompasses all the display processes described in more detail below.

The databases 134 are seller databases (which detail whether items are available and in-stock), user account databases, order databases, RFP template databases, RFP databases, etc. Databases 134 help maintain the information in some capacity and include all current and future database technologies. Databases 134 comprise all forms of memory storage and retrieval, whether short or long term storage, and may be used for creating, maintaining data of the processes described in more detail below.

Artificial intelligence (“AI”) engine 136 may be a separate engine or incorporated into each of the other engines. AI engine 136 could be separately built into the interface engine 120 to help with communicating more efficiently and effectively with individual users, such as understanding a user is a beginner or more sophisticated in their use of the procurement system and processes. AI engine 136 encompasses the artificial intelligence aspects of certain processes described below.

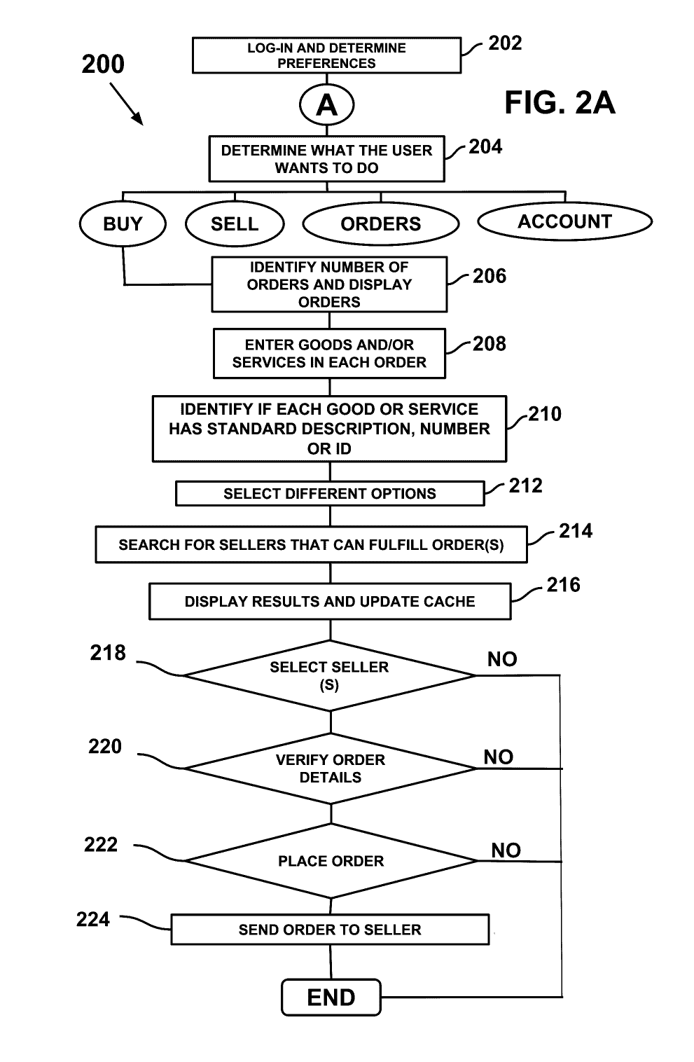

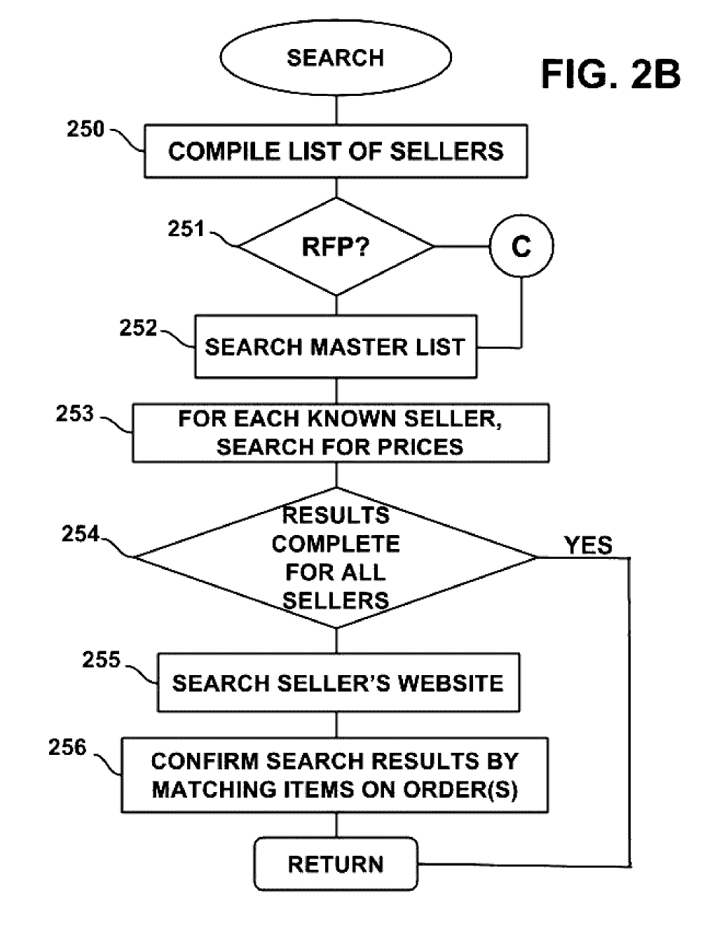

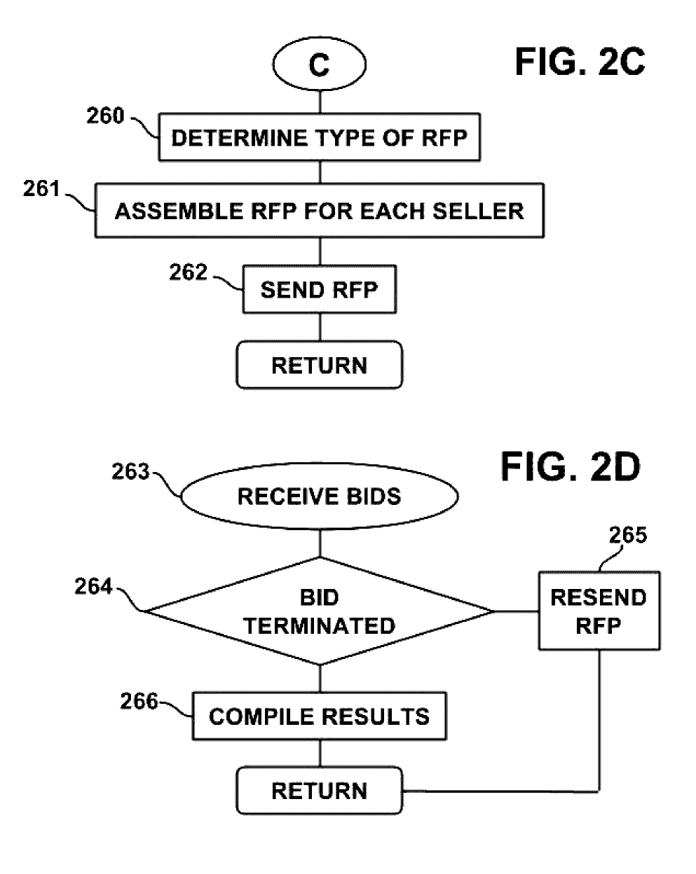

FIGS. 2A and 2B illustrate process 200 of a user (buyer or seller) who uses a device 112 to access the services offered by procurement system (“PS”) 110 according to an embodiment of the present invention. An application can be downloaded to the device 112, where a user (buyer, seller) accesses the application on its device 112, opens the application and begins executing or running the application.

In step 202 (FIG. 2A), device 112 displays the log-in screens, whereby a user can log-in into PS 110. A user enters their user ID (or email address or another unique identifier) and their password into their device 112. This information is transmitted from the user's device 112 to PS 110. Upon receipt of the user ID, password and other pertinent log-in information (device ID, port ID, location, security information, etc.), PS 110 checks to see if the log-in information matches information in its database pertaining to that user, and if the information is correct, PS 110 opens or begins a session with the user. A session can be saved at any point in the process so that data entered by a user is saved and not lost. A session can be restarted at the point from which a user ended it.

The log-in information automatically correlates the user who is signing in to information about the user stored in the PS 110 database. Based on the user profile, PS 110 determines whether the user is a buyer or seller, and what preferences to associate with the user. In cases where a buyer and seller use the same log-in information, an optional step can be inserted into method 200 where the user selects that this current session is either for buying or selling. If the log-in information is not correct, PS 110 or the device 112 will prompt the user again for this information. After a certain number of attempted failed log-ins, PS 110 may bar the user's device 112 from logging-in for a certain period of time and may notify the user via another electronic contact (e.g., text message to the user's cell phone) of the failed log-in attempts. The latest and most current security protocols are embedded into this log-in process to prevent malicious attacks against PS 110.

User preferences are stored in the user's profile, and the user's profile is stored in PS 110, on one or more databases connected to PS 110, or optionally on the device being used, or some combination thereof. User preferences include one or more of the following: (1) whether the account is associated with buying, selling or both; (2) identification of the particular user device—for example, whether the user device is a mobile device, a tablet or a computer; (3) whether the user prefers to manually type in the responses, use pull-down menus, or use voice interaction (using a computer-generated voice (CGV)), or some combination thereof; (4) what payment options (Visa, MC, Discover, AMEX, Paypal, bank account, etc) the user prefers; and (5) what initial prompts, screens or CGV queries should be asked to this particular user.

Once the session has been started, in step 204 (FIG. 2A), using a series of default or user's customizable display screens, prompts, or CGV queries, PS 110 determines what the user want to do during the current session. In one example where display screens were chosen as the preferred method of interaction between the user and PS 110, the user is provided one or more buttons or icons. These buttons or icons can be individually customized by a user, or automatically populated by PS 110 based on an analysis of the user's past interactions and history. Assume the user chooses to display past orders on the first buttons being displayed. The buttons or icons provided to the user could be populated with each of the past orders. The user can choose to display any number of the past orders, for example choosing to display the last six orders. This could be used where a user had placed previous orders and wants to start a new order based on a past order, or reorder the same items that were ordered in a previous order.

In an example where the user would rather use prompts, PS 110 displays on the user's device a series of prompts, possibly starting with “what do you want to do today?” In one embodiment, there may be a pull-down box where the user can select from the following options: new order, reorder, sell, account. These initial prompts can be customized by the user, so that the user is provided prompts most suited to their use of the PS 110. In another embodiment, the user can just type in their responses, or if CGV is enabled, speak the response to the question. What the user says may or may not be shown.

In an example where the user would rather use CGV queries and prompts, the user's device using CGV, queries in step 204 with “what do you want to do today”. The PS 110 system may use this question as the default question if the user had not chosen another initial question. In the user's profile, the user can select the default question, or can create a preference for which question to start. Instead of asking “what do you want to do today”, the CGV may ask “do you want to place a new order” or “do you want to reorder”, or “do you want to start a new order based on a past order”. These alternative questions are just three examples of the hundreds of different types of questions that may be initially asked of a user and which can be customized by a user. Having the capability to select, choose or program one or more initial prompts, screens or CGV queries, this feature helps the user customize their initial interaction so that user can promptly begin with what the user normally wants to do.

In cases where the user repetitively performs the same type of action, this customizable interaction is important. PS 110 may recognize a trend in what a particular user wants to do and may automatically prompt the user with the specific actions the user traditionally performs. The trend-recognizing feature can be enabled or disabled. There are many different options available to the user, and having a short-cut to their customizable preferences, rather than always having the same default and initial prompts, screens or CGV queries for every user, is one of the advantages of the present invention. This customizable user feature is important because a lot of time can be spent just to get to the right screens, prompts or CGV interactions before actually starting what the user wants to do.

Based on how the user wants to interact with PS 110 and the initial user-selected prompts, screens or CGV queries, the user indicates to PS 110 with what they want to do, such as the following: “buy”, “sell”, “orders” or “account”. “Buy” indicates that the user wants to buy items or services or place a new order. “Sell” indicates that the user wants to sell goods or services. “Orders” indicates that the user wants to view current and past orders, change one or more orders, cancel one or more orders, or reorder based on a past order. “Account” indicates that user wants to update their account information, including payment information, user preferences, or delivery preferences for example. It is important to realize that other words or categories may be included then those listed here by example.

In one embodiment, PS 110 in step 204 (FIG. 2A) provides to the user's device 112 an initial, screen, a prompt or CGV question that says or inquires “what do you want to do today”. Based on the response, PS 110 can determine during the current session whether the user wants to “buy”, “sell”, “orders” or “account”. In response to this query, the user may type or speak for example: “I want to buy a TV”; “new RFP listing”, “buy a car”, “purchase groceries”, “update inventory”, “order a pizza”, or “upload new order”. Based on what the user enters or speaks, PS 110 can determine whether the user is buying, selling, or changing their orders or account. The screens, prompts and/or CGV queries can either be stored in the application that had been downloaded on the user's device 112, or can be transmitted in real-time by PS 110 to the device 112 over the network 114.

In some embodiments, the interactions between a user and PS 110 are based on a user's profile. There are different levels of interaction between PS 110 and the user's device 112 which can be specifically tailored and stored in the user's profile. A user's profile includes user's preferences (including initial screens, prompts and CGV queries as described above), history of what occurred in past sessions, history of past interactions during those sessions between the user and PS 110, and the account history. Preferences are initially set during account set-up or registration, and later modified or updated from the interaction between the user and PS 110 during sessions. For example, during account set-up or registration, the user is provided a series of preferences, prompts and/or CGV questions to determine what they intend to do when using a particular account. Examples include (i) whether the user prefers to enter data or information by speaking (voice interaction using CGV queries) or by manually by using a keypad; (ii) whether the account will be used by a buyer, or seller or both; (iii) selecting the type of goods or services interested in purchasing or selling from a list of goods or services; and (iv) the preferred language of the user (English, Spanish, etc.). There are many different user preferences in addition to those described herein that can be stored in the user's profile.

The user's profile also can be constructed from patterns of behavior from past sessions, past interactions, and account history. Historical information includes what types of goods/services the user viewed, searched and compared in prior sessions; whether the user is a frequent, limited or new user; the frequency of the number of past sessions (daily, weekly, monthly, some other period of time); the specificity, level or degree of answers provided by the user in past sessions; and, the number, frequency and type of goods/services purchased or sold in completed or open orders. The user can enable PS 110 to analyze and track the historical user data to discern trends or patterns, based on items or services purchased prices paid and when each of the orders was placed. Using the constantly evolving and dynamic data and information associated with a user's profile, PS 110 will be able to determine the sophistication of the user and which screens, prompts or CGV questions to provide to the user during method 200.

Each user (buyer, seller) has different levels of sophistication in how they enter information, search for particular information, how they want information displayed and how they purchase or sell. Some users know exactly what they are searching for including knowing the details about a specific item (e.g., name of item, model number, and manufacturer). During sessions with such users, PS 110 asks the user a series of questions specifically targeting particular items. For example, when the user logs-in, instead of displaying “What do you want to do today?”, PS 110 may ask the user, “Please state the name and model number of item you want to purchase?” For other users, they may have a history of reordering certain items at certain times during the month. When these users log-in at around the same time the following month, they are initially prompted with “Do you want to reorder your items from last month?” For other users, they may want to browse a particular type of goods or services, and then make a decision on a comparison of those goods or services. In this case, PS 110 may ask the question, “What do you want to do today?” because PS 110 has determined that these user have limited or no patterns of buying. For other users, they only have a history of buying products. In this case, when that particular user logs-in, PS 110 will send a series of display screens, prompts or CGV questions for buying a specific type of product, and may inquire “What do you want to buy today?”

In one embodiment, in response to what the user wants to do (step 204) the user has at least four options: (1) review and buy products, (2) update product inventory and prices, and/or update service fees, (3) review and change past orders, and (4) review and update account information. This specification will first describe how a user purchases one or more items using one or multiple orders, followed by a discussion about selling products, followed by how to review and change past orders and followed by how to review and update account information, and lastly how to start a new RFP listing and how to review RFP listings.

Buying Goods and/or Services

Based on the response to the initial default or customizable query, PS 110 will direct appropriate display screens, prompts or CGV questions based on what the user wants to do. When the user wants to buy goods or services, or place one or more new orders, PS 110 in step 206 (FIG. 2A) asks the user to identify the number of orders. The user can enter a number (or word corresponding to a number) or select from pull-down menus, the number of orders the user wants to place. The user's device may automatically display “1” as the default number. In this case, the user just clicks on “Next” or something similar to activate the first order to be displayed. Instead of “1” being the default number, alternatively the user can store his default number (of orders) in their user's profile.

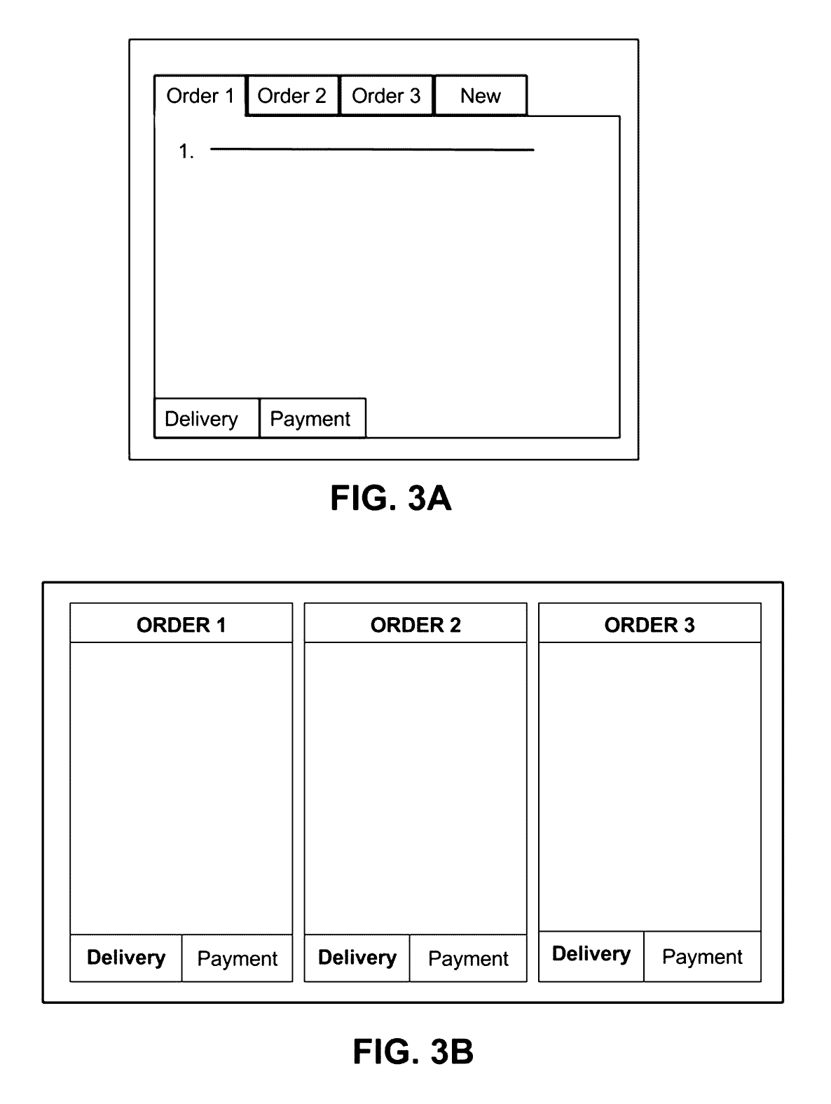

Once user enters or accepts the number of orders, the user's device will display one or more orders according to the default setting or how the user would rather the orders be displayed. How the orders are displayed is customizable by each user. In one embodiment, in the preferences screen of the user's profile, the user is shown a variety of displayable patterns for multiple orders, and can select the one that the user prefers. In one example, for orders being displayed in a tab form, this is illustrated in FIG. 3A. In FIG. 3A, the first order is displayed on top of other orders, where the other orders are tabbed underneath the first order. The user can select Order 2 or Order 3 by selecting the corresponding tab. In another example where orders are displayed next to each other, this is illustrated in FIG. 3B. Each order can be selected by selecting any region or selection regions of that order. If a new order is selected in FIG. 3B, the screen may show the new order next to the other three orders by automatically resizing the four orders to proportionally fit within the confines of the screen dimensions.

How each order is displayed can also be customized by the user. In a default mode, the item displayed may only show the name of the item and quantity. In other embodiments, the user can select which features or characteristics of each item the user wants to be displayed and whether to displayed in an Excel-type style (with or without grid lines). For example, the user may want to display the name of each item, quantity, model and/or style number. In another example, the name of each item and a picture of the item are the only features or characteristics displayed. The other features or characteristics can be displayed in a pop-up window or a separate area on the screen by moving a cursor over the item, selecting the item or in any of the other current ways such “hidden” information can be displayed.

After the orders are displayed, the user can change the number of orders and delete orders. These options are available by any means known to those skilled in the art. For example, a “delete” button could be placed somewhere on the order or on the screen. By selecting the “delete” button, a specific, user-selected order would be deleted and removed from the screen. An example for adding a new order to the screen, the user could select the “new” tab in FIG. 3A, whereupon the new tab would become “Order 4” and a “New” tab would be displayed next to “Order 4”. There are additional ways to delete or add orders than those described herein, those additional methodologies being included in the present invention.

After the orders are displayed, the user in step 208 (FIG. 2A) enters or identifies each of the specific items or services in each order. The user has the option of manually typing in a list of items, speaking each of the items in the user's device (where the spoken words are converted into words and displayed), using a series of prompts, or downloading the items from a file or another program to automatically create one or more orders, where each order has specific items being ordered. Items placed in one order can be moved to another order or a trash can using drag and slide features known to those skilled in the art.

In an alternative embodiment, the user can assemble the current order from one or more past orders. A list of past orders would be displayed to the user, whereupon the user would populate the current order with all or selected items from the past order, using copying/pasting, drag/drop or other currently available methodologies. In another alternative embodiment, the user can display all items from previous orders, sort them by name, order date or other criteria, and then select the appropriate items and move them into the new order using copying/pasting, drag/drop or other currently available methodologies.

After some or all the items are entered into each order or while the items are being entered into the order, PS 110 determines in step 210 (FIG. 2A) whether each item or service has a corresponding standard, unique identification, such as for example, UPC code, manufacturer's style number or model number. This identification step 210 can be initiated by the user by selecting an appropriate button or icon, or will automatically start running in the background while the user is entering the item. One of the great advantages of the present invention is that PS 110 helps the user identify or will provide the standard, unique identification (e.g., UPC code, style number, model number, etc.) for each of the consumer items in the order.

In one embodiment, the unique identification for each consumer product is provided by a UPC (Universal Product Number) number, code or symbol. The UPC symbol is the most recognized barcode in the United States, since it appears on almost every consumer retail product. The UPC symbol is the barcode representation of the GTIN-12 which consists of twelve numeric characters that uniquely identify a company's individual product. The GTIN-12 number is part of the family of GS1 global data structures that employ 14 digits and can be encoded into various types of data carriers. In other embodiments, instead of using the UPC code, PS 110 may alternatively use the unique style number or model number as provided by the manufacturer or another organization or association.

In other embodiments, PS 110 may generate a unique code or number for the consumer good or product, or for a particular type or kind of service. This number may be internal to the PS 110 which translates the standard, unique identification into its own unique number or identification. The translator would use a database, where the product's UPC number, style number, model number also contains the PS 110 unique number.

When searching for services, PS 110 guides the user through a series of questions relating to what type of service is being requested. The screens for ordering a service can be different from those screens relating to ordering one or more items or products. Services are typically based on the type of work is to be performed and the length of time preparing for and actually doing the requested job. PS 110 will guide the user to finding the service that the user wants to locate, hopefully finding a general or specific category of the type of service being requested. Within the category may be other categories, so that when the search is performed for people who can perform the service, matches can be found quicker using a standardized service description, name and or unique number. For example, services for car mechanics is different from services for a plumber or a family law attorney, however, these types of services can be standardized by the type of service needed. In addition, each of the websites of the car mechanic, plumber and family law attorney would standardize the information about the services that are provided which is incorporated or embedded in the website using any way known now (or in the future) by those skilled in the art. By standardizing the service description and associating it with a standard number, PS 110 would have greater likelihood of finding matches to the services being requested by the user.

Each manufacturer typically is responsible for assigning a unique style number, model number or UPC code number to each of its products. Some follow the conventions set forth by standard setting organizations, such as for the UPC code. PS 110 will have access to these unique codes and corresponding descriptive criteria whether downloaded to a database connected to PS 110 locally or remotely via the network 114. Also, each manufacturer may update or download the current information available about its consumer products to a database accessible by the PS 110.

The standard, unique identification (e.g., UPC code, style number or model number) can be displayed with the name of the product. However, it is not necessary that the identification be shown on the display screen to the user. This information can be kept in the background without displaying it to the user. Whether to display the information or not may be a preference that can be enabled or disabled by the user. When PS 110 finds a UPC code, style number or model number for a particular consumer item or product, this can be indicated to the user via changing the color of the item (or number in the list), boldfacing the item or number, underlining the item or filling-in or changing the color of a bullet. If the cursor is moved over the bullet or another part of the name of the item, the UPC code, style number, or model number would be displayed in a small pop-up window.

Each of the consumer products entered by the user includes the name of the item and if known, any of the following: model number, style number, quantity, brand, size, color, UPC code, etc. Sometimes a user needs assistance in identifying the correct information about a particular consumer item or product. In one embodiment, the user could use a general search engine (e.g., Google, Yahoo, Bing) to first identify the consumer item, including the name, model number, style number and/or UPC code. In another embodiment, the user could enable the PS 110 to help in the identification. Depending on the type or name of each item being entered, additional screens, prompts, CGV queries or pop-up screens are activated to help in identifying particular characteristics, functions and details about a particular item or service, including a model number or other unique identification information. Whenever the user enters an item or a service, additional screens, prompts, CGV questions, pop-up menus or other screens associated with such goods or services are automatically activated to help further identify a particular item or service.

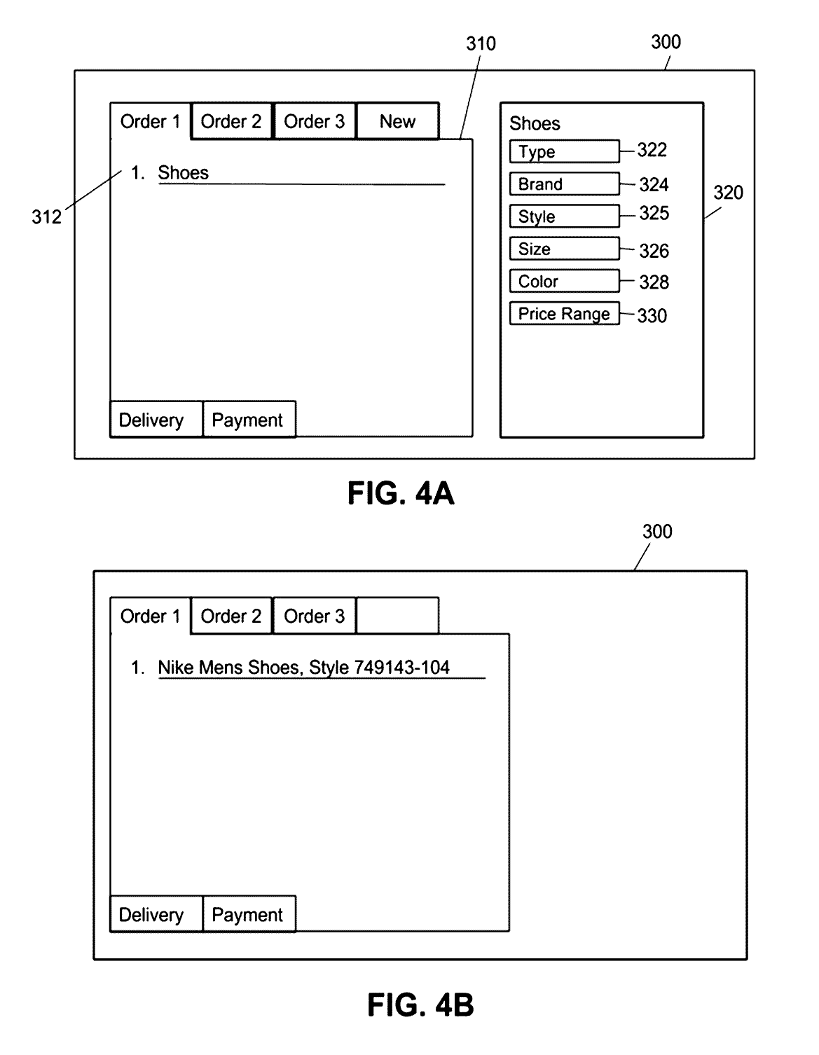

For example, suppose the user wanted to buy a pair of shoes. “Shoes” by itself is too generic a term for searching, because there many literally hundreds of different types and brands of shoes. So when the user types in “shoes” 312 into the list 310 as illustrated in FIG. 4A, a pop-up menu 320 is activated where the user can further select a type 322 (e.g., mens, womens, child), a brand 324 (e.g., Nike, Adidas, Puma), a style 325 (e.g., sports, basketball, soccer, casual), a size 326, a color 328 and a price range 330. There are other criteria that may be displayed in addition to the criteria illustrated in FIG. 4A. These selections can be pull-downs menus, free-form data boxes for manual entry, or CGV queries. When in CGV mode, the user is queried as to each additional characteristic, function or detail associated with each item. The user is given a chance to respond before moving onto the next characteristic or feature. Once the user selects information pertinent to the shoes from pop-up menu 320, the information may be displayed as illustrated in FIG. 4B, where the name of the shoe and style number is shown. By moving the cursor over the “Nike mens shoes”, the pop-up box 320 will be displayed, showing the additional details associated with the particular consumer item. It is not necessary that the additional information be shown on order list, although the user has the option of displaying it. Also an image of the consumer item could also be displayed instead of a description of the item as shown in FIG. 4B.

In embodiments of the present invention, when the user enters an item or a service, additional screens, prompts, CGV questions, pop-up menus or other screens associated with such goods or services can be automatically activated to help further identify characteristics, functions and details about particular item or service. In other words, the additional screens, prompts, CGV questions, pop-up menus or other screens are specifically tailored to the type of goods or services being sought. This gives the present invention the advantage of targeting and identifying specific characteristics, functions and details about a particular item or services before a search of the items in the order is performed. Specific details about a particular item may considerably differ from the specific details associated with another item. For example, specific characteristics about shoes are different from characteristics associated with tennis rackets, golf clubs, mattresses, tires or a 1900's grandfather clock. For certain categories of goods, the user has the option of choosing “used” goods, “new” goods or “both”.

The user has the option of downloading one or more files, or receiving data from another device, that automatically populates one or more orders, and for each order, the list of items being sought in each order. In one embodiment, users can upload an Excel document containing their procurement orders from their device 112 to PS 110. Having the ability to upload procurement orders for construction, where the number of orders and items per order can be extensive, detailed and large. In some construction software packages, such as BuilderTrend, Co-Construct, ProCore, UDA ConstructionSuite, procurements orders can be converted into an Excel document, which then can be automatically uploaded to PS 110. PS 110 allows a builder/contractor/subcontractor the options of viewing each of the orders, changing each of the orders, listing the order as a RFP listing, and searching for suppliers for each individual order, and then placing each of the orders by a specific date. PS 110 allows the contractor the ability to time-delay or activate each of the orders for review on specific dates, reminding the contractor to place the order by a certain date.

It will be appreciated that step 208 (FIG. 2A) and step 210 (FIG. 2A) can execute in parallel, or sequentially. After step 210 is completed, if more items need to be entered, method 200 returns to step 208 via indication by the user (e.g., selecting a new line in the order) so that more items can be entered into an order. The user can add and delete items from an order at any time before or after a search has been performed. A user can enter their items, goods or services into the order, and PS 110 will either identify the standard, unique identification for such items, goods or services upon the user selecting an appropriate button (e.g., “next”), or automatically by default or if enabled by the user in their user's profile.

In step 212 (FIG. 2A), PS 110 provides the user with additional options relating to the order, including for example, selecting preferred sellers, selecting different delivery options, or indicating whether the order is a RFP (request for purchase) order. These are examples of some of the different types of options available for each order, and other type of options are possible. These buyer options are displayed to the user using any way known to those of ordinary skill in the art. The user selects these options using any way known now (or in the future) to those of ordinary skill in the art. A RFP order can be a separate category from buying. RFP orders or listings are described below.

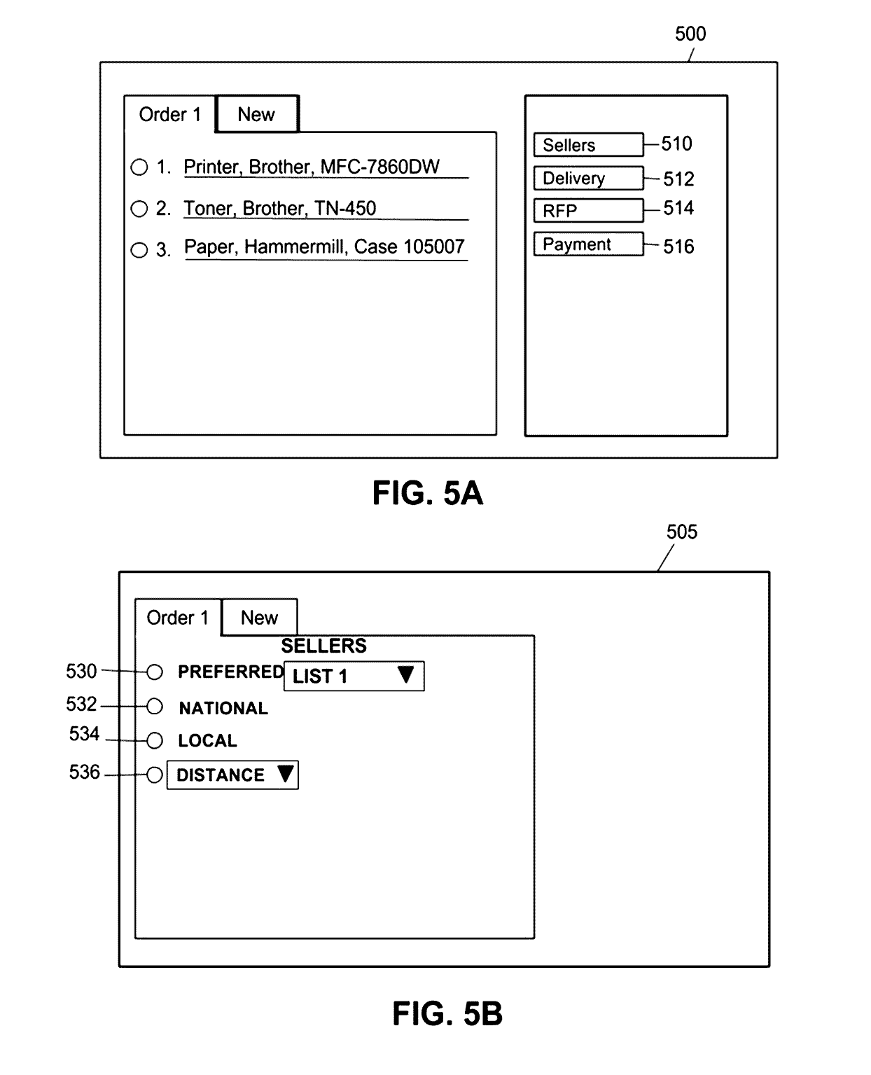

FIG. 5A illustrates an example of an order screen showing seller options 510, delivery options 512, RFP options 514 and payment options 516. To select one of the options, the user clicks or selects the particular box using the cursor and mouse, or any way known now (and those in the future) to those skilled in the art. Upon selection of one of the options, a new screen may be displayed with the current selectable features pertaining to that option, or a part of the current screen would display the current selectable features. For example, when the user selects “sellers” option 510 on screen 500 in FIG. 5A, a new screen 505 may be displayed as shown in FIG. 5B.

FIG. 5B illustrates a screen 505 showing a few examples of what “seller” options 510 are available. These options include a “preferred” seller list 530, sellers having “national” presence 532, sellers having a “local” or region presence 534, and sellers located within a select “distance” 536. Regarding the “preferred” seller list option 530, there may be multiple preferred sellers lists, where each of the lists are customizable by the user to include sellers for the type of products that the user is interested in purchasing. The user can create separate lists of preferred sellers, for example, one list containing sellers who sell vitamins and another list containing sellers who sell pizzas. Seller lists can include wholesalers, retailers, returning customer features such as preferred customer numbers for select discounts, or combinations of these.

Sellers can be added to and deleted from any of the preferred seller lists using any way known now (and those in the future) to those skilled in the art, including for example, typing in the names of the preferred sellers, selecting sellers from a list of sellers, selecting sellers from a map of where they are located, and/or selecting from one or more past orders. The preferred sellers lists could be stored locally, in the user's profile or some other location accessible to the user's device. There can be multiple preferred sellers lists, each having a different name to indicate what the list may include. Each of the preferred sellers lists could be viewed on the screen using any of the ways known now (and those in the future) to those skilled in the art.

Embodiments of the present invention may partner and interact with known websites who already provide lists of different sellers. For example, Yelp is a website that contains among other things a list of restaurants. The user could view lists of restaurants from Yelp and add all or select ones of these restaurants to different lists.

If the user selects the “national” sellers 532, this would include such retailers having a national (or international) presence, such as for example, Walmart, Target, Home Depot, Lowes, Starbucks, Pizza Hut, and McDonalds. These national sellers could be added to and deleted from the selected one of the preferred sellers lists as described above. Alternatively, the “national” sellers 532 could have national sellers lists instead of including these sellers in preferred sellers lists described above. If the “national” sellers list is selected, by default this list may contain all the national sellers even if such a national seller is not near the current location of the user.

If the user selects the “local” sellers 534, this would include local or regional sellers. Local or regional sellers are those retailers or companies that have one store in the local vicinity of the user. Local sellers would mostly include “mom & pop” type stores. However, the local sellers also may include a local store of a national chain. Local sellers may be preferable to some users, especially for those in smaller cities and towns where there are no national chain stores. The local sellers could be added to the preferred sellers lists as described above, possibly naming the list, “Local Sellers Laguna Beach”, for example. In another embodiment, the “local” seller option 534 could contain multiple lists, similar to “preferred” sellers lists 530, each of the local sellers lists can be customized by the user. Local sellers could be added to and deleted from the local sellers lists using those ways known now (and those in the future) to those skilled in the art, such as for example, select or highlighting sellers and then selecting “add” or “delete” options in a left-click pop-up window.

The distance option 536 illustrated in FIG. 5B provides the user with the ability to search sellers within a distance from the known, user location, a zip code, a specified address, or from a point manually selected by the user. Pull-down menu 536 may have for example the following increments: 1 mile, 3 miles, 5 miles, 10 miles, 15 miles, etc. Instead of using a pull-down menu option 536, the user may have the capability to manually enter the distance. The distance entered is equal to the radius of the circle drawn from the point selected by the user.

The user has the ability to select one or more of the options 530, 532, 534 and 536, giving the user great latitude on which sellers to search for prices and availability. When the user selects one or more of the options 530, 532, 534 and 536, a map of the current location of the user could be shown with a circle having a radius equal to the “distance”, and the sellers included in the map. The user may be able to select sellers from the map (or a corresponding list) and add them to “preferred”, “national”, and “local” lists. How the map and sellers lists are displayed can be any way known now (or in the future) to those skilled in the art.

Returning to FIG. 5A, when the user clicks on the delivery options 512, the user is given options for delivery, including for example, free, in-store, regular, and expedited. Other options for delivery are included in addition to those described herein. The delivery options are displayed to the user using any way known now (or in the future) to those skilled in the art. The user can select the delivery options for a particular order or orders. For example, suppose for the items shown in FIG. 5A for “Order 1” (printer, cartridge, paper), the user wants the printer delivered the next day, but will pick-up the cartridge and paper at the store. To do this, the user would separate “Order 1” into two separate orders, each order having a different delivery option. In one order, the Brother printer would have “next day” delivery, while in the other order, the toner cartridge and the paper would have “pick-up from store” option.

In FIG. 5A, when the user selects “RFP” options 514, the user can make a choice as to whether “Order 1” will be a RFP (request for proposal) order. A RFP order is a special order that gives sellers (default or those selected in seller options 510) the opportunity to bid on the group of items in the order. A RFP order is one where the information is sent to one or more sellers, and each of the sellers, within a selectable time period, makes a bid on the items. RFP options 514 may include a selectable period of time and whether the user would specify the only terms or conditions or permit each seller to specify their own terms and conditions. When the user selects RFP options 514, these RFP options (e.g., enable/disable, period of time, buyer's terms & conditions, and seller's terms & conditions) are displayed using any way known now (or in the future) to those skilled in the art. The user can select a period of time for the RFP to remain open, for example, 1 hour, 1 day, 1 week, etc. The user may manually enter this information or select from a clock and calendar. If the RFP option 514 is selected and enabled by the user, if a seller does not respond or does not accept RFP orders, then this information could be displayed on the screen to the user.

In the example shown in FIG. 5A, if the user wants to purchase the printer, cartridge and paper, but would like to RFP the items, the list of items would be sent to the sellers (chosen by default or under “sellers” option 510). Each seller would have the opportunity to bid on the items, provide an itemized cost break-down and total price. Each seller would also be told how the user wants the items delivered (as selected from the “delivery” options 512) and how the user intends to pay (e.g., cash, check, credit card—“payment” option 516). Each of the sellers would also be notified whether the seller is agreeable to the specified delivery options and payments options, and any other terms and conditions specified by the user, or if permitted by the user, the seller's own terms and conditions. After receipt of the RFP, the seller would make a bid if the seller could satisfy the terms and conditions of the RFP, including for example, delivery preferences and payment preferences. Each bid by a seller is electronically sent to the PS 110 for processing as further described below.

In FIG. 5A, when the user selects “payment” options 516, this option would display to the user how the user intends to pay for the order. For example, cash or cash on delivery (COD), check, credit card or any other payment method. Reseller information may be included in this option, as the items in the order would be purchased tax-free. These payment options 516 are displayed and selected by the user using any way known now (or in the future) to those skilled in the art.

Returning to process 200 in FIG. 2A, when an order has been created in step 210 and the different options selected for the order in step 212, PS 110 determines in step 214 (FIG. 2A) whether to perform a search for the items in the list and determine whether there is a seller who can fulfill the order. The initialization of the search may be via user input such as for example, selecting “search”, “next” or something similar for PS 110 to know to begin the search. The search can be performed on one or more orders simultaneously or sequentially. The user has the option to indicate which sequence to perform on one or more orders, but in one embodiment, the sequence of the search is performed on order 1, followed by order 2, up until the final order. The user is also given the option of making order 2 become order 1, and order 1 becoming order 2 by reorganizing the order tabs or moving an order to a new position in the queue, display or tabs.

### Inventory and Price Search

In one embodiment, the search (step 214, FIG. 2A) is performed according to the steps shown in FIG. 2B. In step 250, PS 110 compiles a list of sellers from the “sellers” option in the order. In some orders, the buyer may already have a list of preferred sellers and would like to obtain prices only from these sellers. In other cases, the buyer may want to search for other sellers in addition to the preferred sellers. PS 110 uses the information about the “sellers” option to compile a list of potential sellers, including national, local and those within a select distance. For local sellers, PS 110 will search its master seller list for sellers within a select distance from the seller. The distance can be selected and changed by the user for each order. There is a default distance that also can be changed by the user to apply to all orders.

PS 110 creates, updates and maintains a master list of sellers. The sellers master list does not have to be a list, but can be stored in any form known to those skilled in the art, including object oriented or database technologies. The master seller list may contain sellers who are grouped by some type of geographical location (e.g., state, county, city, region), and then grouped by the types of products being offered by the seller. For example, there may be list for all sellers in the state of California, which then can be scaled down by a particular county, city or other select region. Within each city, the type of seller would be specified, as for example, restaurants, gas stations, groceries stores, department stores, home goods, warehouses, lumber yards, etc. Having a tree-like structure and organization of sellers, this organization of sellers helps PS 110 to quickly determine which sellers are appropriate for the each particular order or group of orders.

Once the seller list is compiled in relation to a particular order or orders based on buyer's preferences or default settings, PS 110 determines in step 251 whether the order is designated as a RFP order. A RFP order performs different steps from an inventory, price search and lookup. The step of whether to send a RFP order to a seller can be performed at different locations in the price search rather than where it is presently located in the process shown in FIG. 2B. In one embodiment, the RFP could be sent before any price lookup is performed on PS 110 or sellers' resources (e.g., databases, described below). However, in the event that a RFP is combined with price lookup, the RFP part could be sent (1) after a price lookup from PS 110 resources and the sellers' resources; (2) in parallel with a price lookup; or (3) for items that have no pricing from the price lookup. This means that step 251 could be performed at different locations or places in the process shown in FIG. 2B. An order that is not designated to be a RFP order will be described first, followed by a discussion of the steps performed when the order is designated to be a RFP order.

If the order is not a RFP order, PS 110 determines in step 252 (FIG. 2B) whether each of the sellers (from the compiled list) has (1) inventory and price cache/list/database (maintained by PS 110); (2) a local inventory and price database for each product that seller is selling (remotely maintained by the particular seller); and/or (3) a remote inventory and price database associated with a particular seller (maintained by the particular seller). If each of the sellers on the compiled sellers list has prices in the inventory and price cache/list/database, or one of the local or remote inventory databases, PS 110 in step 253 (FIG. 2B) then searches the inventory and price cache/list/database or each of the sellers' inventory and price databases for prices for each of the items in the order. If the prices are contained in the cache/list/database or in a local or remote inventory database, PS 110 may not have to search the seller's website.

The inventory and price cache/list/database is maintained by PS 110, and is a compilation of items, goods, or products and prices per seller that were previously looked-up by other sellers within a certain period of time. For example, two users could be searching for the same item from the same seller, except user 2 performed its search some time, say for example ten minutes after user 1 performed the search. By storing the searches from previous searches for some period of time (e.g., 1 hour, 2 hours, 6 hours, 12 hours, etc.), PS 110 does not need to re-search the same item over and over again from the local or remote inventory databases of the seller. Once an order is placed, the quantity available of particular items will have to be updated and coordinated with the quantity available by the seller, so as not to exceed the stock that is currently available from the inventory of a particular seller.

A seller's local inventory database is a database locally connected to the PS 110. Locally connected means that the database is connected via wireless or wired technology to the Internet, or to a local area network (LAN), wide area network (WAN) or something similar. The seller can access and update this “local” inventory remotely over the network 114. Alternatively, if the seller uses a remote inventory database, this means that the database is connected remotely over the network 114 to PS 110, where PS 110 knows the location or address of the remote database and can access that database remotely via network 114. By having the seller maintain its own database at one of its own facilities, the seller only needs to maintain one database, making that inventory available to PS 110. Of course, all current and future security protocols are included so that the seller's databases, whether local or remote, are not compromised, hacked and/or damaged by unauthorized people. When referring to a database, whether local or remote, it is understood that multiple databases may be used and can be apportioned to certain products or items as PS 110 or the seller deems necessary.

The seller's local or remote inventory database will have a searchable database by name and/or unique identification number (UPC, model number, style number, etc.) that includes each of the seller's products. Each of the products has a (1) price, and if necessary, a special price for a period of time (e.g., daily, weekly, monthly, etc.); (2) whether in stock (and the quantity available); (3) delivery options (e.g., whether the itemed can be picked-up or whether it can be delivered by the seller using a carrier). PS 110 searches the cache/list/database and/or each database of each of the preferred sellers and compiles a list of prices (and other criteria—e.g., whether in stock or not) for each item in an order.

PS 110 determines in step 254 (FIG. 2B) whether a price of each item in the order could be located for each of the sellers in the compiled sellers list. If all items in an order have been priced and all the prices are known for each seller, then this means that the order results are complete. If PS 110 in step 254 (FIG. 2B) determines that all sellers have provided the prices for all items in an order, then the results are displayed to the user in step 216 (FIG. 2A). If all the prices are not known or determined from the cache or sellers' databases, then a search of those items missing from the results will be performed on a particular seller's website, or alternatively a RFP order can be sent to those sellers having missing prices.

In alternative embodiments, where an order includes RFP and regular pricing, step 251 (FIG. 2B) could be moved to after step 252 (FIG. 2B). What this means is that a RCP order can be combined with a regular price lookup. In this embodiment, PS 110 would first locate the prices for items on the list using the processes described in step 252. If all prices for an order were found for all sellers, then PS 110 would display the results to the user. However, in cases where all prices were not found, instead of searching the website of one or more sellers whose prices could not be located, PS 110 issues a RFP to particular sellers that have missing prices in an order. Having the RFP issued only on items without a price helps sellers provide prices for select items instead of all items. If the RFP is issued after PS 110 searches a seller's website, then that may help eliminate the RFP altogether or make the bid on only a few remaining items.

Suppose in one example for the items shown in Order 1 in FIG. 5A, the buyer selects the “sellers” option and selects Staples, Walmart and a family-run local office-supply business, named ABC Office Supplies. The buyer turns off the feature where sellers could be found within a select distance. In this example, PS 110 first compiles a list of sellers, this compiled list including Staples, Walmart, and ABC Office Supplies. PS 110 then searches its master sellers list and determines whether Staples, Walmart and ABC Office Supplies each has an inventory available from the inventory and price cache/list/database, or from a local or remote inventory database of products associated with those sellers. In this example, PS 110 finds that Staples and Walmart each has a separate, remote database and ABC Office Supplies has a local database. None of the inventory from Walmart, Staples or ABC Office Supplies is available from the inventory cache/list/database. PS 110 then searches the remote databases of Staples and Walmart, and the local database of ABC Office Supplies and determines the prices and corresponding information of each item in order 1 (printer, cartridge, paper). PS 110 then compiles the prices and other information for each item in Order 1 for each of the sellers. The prices and other information are displayed by each seller to the buyer.

In this example, suppose the price of the paper was missing from Walmart and from ABC Office Supplies. If the RFP option was selected, then PS 110 could send a RFP to Walmart and ABC Office Supplies to bid on the price of the paper. However, in some embodiments, PS 110 would search the website of Walmart and ABC Office Supplies to determine whether a price could be located for the paper. If a price could be located from the Walmart's website, then a RFP would not be issued. If a price could not be located from the website of ABC Office Supplies, then a RFP would issue only for requesting a price on the paper.

If PS 110 in step 254 (FIG. 2B) can not find prices for each item in the order from the inventory cache/list/database or the local or remote database for each of the preferred sellers, PS 110 searches in step 255 (FIG. 2B) for the prices from the website associated with each of the sellers whose prices and other information are missing. In one embodiment, PS 110 uses a Google Custom Search API (GCS API). GCS API is capable of searching a particular website and then locating specific information from that website. A search string value (e.g., an item on the list) is processed entirely by the GCS API, which converts the search terms into two primary Boolean structures using “AND” and “OR” operators. The two values are presented against the GCS API website results, which returns a result sorted by probability. The search is performed in whole using the power of Google's open-source search functions to leverage computational mathematics, using both iterative and heuristic-based methods. A mathematically rigorous convergence analysis is performed, by Google, against the search terms to deliver the best possible result. All of which is accomplished entirely using GCS API and requires no proprietary code on the source website. GCS API is not the only tool available for searching a website. Alternatively, Bing Search API or Yahoo Boss Search API could be used as well.

GCS API searches select sellers' websites for items on the order returns results to indicate to a degree of probability whether the seller is selling such items. Although GCS API has built-in filtering options, PS 110 will take the results and determine or verify in step 256 to a degree or percentage of certainty that that each of the products found from a seller's website actually matches one of the items in the user's order. For example, this may be a comparison between the name and/or standardized information including for example, UPC codes, model numbers, style numbers, dimensions, typical price ranges for similar products from same manufacturer or different manufacturers (to weed out products with 5x or 10x differences), etc. This step is optional depending on the GCS API's degree of certainty of a match. If all the prices in the order have been determined, the search process shown in FIG. 2B end and returns to step 216 (FIG. 2A) where the prices are shown to the user.

### RFP Order

An RFP order can be performed in step 251 (FIG. 2B), or after all other prices have been determined from available sources (cache, databases, websites). PS 110 first determines in step 260 (FIG. 2C), the type of RFP that the order is designated to be by the user. The RFP order can be a RFP for (1) for all items in an order for all sellers, (2) for some items in an order for all sellers; (3) for all items in an order for some sellers; and (4) for some items in an order for some sellers. PS 110 then assembles (or creates, compiles) one or more RFPs for which items (all or some) and for which sellers (all or some). PS 110 assembles or creates in step 261 a RFP for each seller based on which items need a price and for the length of time from which a seller can respond with a bid. The RFP can include such information as all or some of the items in the order, an order number, whether the user is repeat customer, how the user intends to pay for the order, how the user wants the items delivered, how soon the user wants the items delivered, and any other information that a seller would need to make a decision about the price to charge for all or some of the items in the order.

A RFP is sent by PS 110 in step 262 (FIG. 2C) to each of the general or a designated account (e.g., email, text, Twitter, or Facebook) of each of the sellers. Each seller is given a prescribed or user-designated time to respond to the RFP. The RFP option 514 (FIG. 5A) has a user-specified response time (such as 1 hour for example) by which a particular seller can respond to the RFP. Once the RFP have been sent, PS 110 waits to take any additional action regarding the order until one or more bids have been received from the sellers. The bids from any of the sellers can be received any time after the RFP is sent.

FIG. 2D is a process that begins once PS 110 receives in step 263 one or more bids or responses to the RFPs. Step 263 may or may not be sequential, but bids can be received at any time after being sent to the sellers. After receiving a bid, PS 110 processes the bid and determines in step 264 whether all prices for each of the items in a particular order has been received from the particular seller. If the bid is incomplete in any way (such as for example, some of the prices are missing from the seller's response), PS 110 can resend the RFP to the seller in step 265 requesting the seller to completely respond to the RFP and detailing what was missing in the last bid. If PS 110 determines that the bid is complete in step 266, then the bid is displayed to the user in step 216 (FIG. 2A). If there is a change in any of the terms preferred by the user, PS 110 notes these changes on the bid as displayed to the user, using for example, different colors in the font or highlighting terms that had changed.

PS 110 displays the status of bids, including those bids that are complete, those waiting for a response from a seller and those that expired due to a lack of response from the seller. It is not necessary to receive all bids for a particular order before displaying the results to the buyer. The buyer can track and view those bids which have been received so as to start comparing what each of the sellers are offering. If all bids had been received or if the response time to the RFP has expired, PS 110 will indicate to the buyer which bids (if any) have been received and display the complete bids to the buyer. The buyer also will be able to view incomplete bids to determine whether to extend the period of time for the seller to respond.

After obtaining or receiving price information from the sellers, the results are displayed to the buyer in step 216 (FIG. 2A) and the internal price and inventory cache/list/database is updated with the order information for each of the sellers. The results can be displayed to the buyer in any way known now (or in the future) to those skilled in the art. For example, the bids can be ordered by seller, starting with the lowest prices or bids followed by the sellers with the higher prices. The display can include special ways to show whether all the user's terms and conditions are met, including whether the user wants them delivered to a house or business, or whether the user wants to pick them up, for example.

Steps 208-216 (FIG. 2A) are repeated for each order, because the user is able to have one order or multiple orders during each session. The user has the ability to search for each order individually before starting a new order, or can enter items in multiple orders and have PS 110 search for the prices sequentially or in parallel. Also, the user can specify when to search for a specific order. For example, say the user wanted to find a printer now, and enters information about the printer in order 1. The user enters the information about the cartridge and the paper in a separate order, i.e., order 2, but will wait until the first order is delivered before searching for the prices for order 2. Upon delivery, and notification to PS 110, PS 110 will then search for prices for order 2 and notify the user that the results are available for viewing. This time-oriented system and process are important for sequential, time-sensitive construction projects, such as for example, building a building or for other types of home improvement projects.

Embodiments of the present invention include multiple, sequential orders that can be created, stored and made publicly available to other users. Such multiple, sequential orders can be viewed by other user, loaded into the order forms, and then customized by the user by moving, deleting, and adding items to the orders, or changing the other customizable options, such as sellers, payment, delivery and RFP options discussed above.

If a user selects a seller for a particular order in step 218 (FIG. 2A), PS 110 will confirm in step 220 (FIG. 2A) the particular details about the order, including for example, delivery and payment options. Otherwise, if no seller is selected, and the user logs off, method 200 ends. If the buyer starts a new order or modifies an order, method could return to step 206 (changing number of orders), or steps 208 (entering, deleting or modifying items in one or more orders). PS 110 stores for some period of time the order information for each user/buyer session, and may not have to search for the information again, but just move the item information and price from one order to another order. For example, for the three items in Order 1 shown in FIG. 5A, the user first searches for prices for Order 1. However, the user finds that the price is more than what can be afforded at the present time, so the user moves the paper in Order 1 to a second order, Order 2. Because PS 110 had already obtained or found the price for all the items in the initial Order 1, PS 110 does not need to re-search for the pertinent prices, but only has to recalculate the individual prices in each order, including recalculating the total prices for Order 1 and Order 2.

Once delivery and payment options have been confirmed, PS 110 displays a button or other icon, or transmits a CGV message to a speaker on user's device, whereby the user can “Place Order” or something similar in step 222 (FIG. 2A). Once the user places the order in step 222, PS 110 will then submit the order to the seller which was selected by the user via any way that is desired by the seller (e.g., email, text, automatic inventory message, etc.) PS 110 will generate a unique order number for this particular order, making it easy to manage throughout the system including modification or cancellation of that particular order. The order information also is stored in the user's account information.

For multiple orders, the buyer is queried to select a seller for each order. Other order options (e.g., delivery, payment) may also be displayed before the buyer has the option of placing one or more orders. This process helps to verify items in the orders before an order is placed, including information related to the seller, delivery and payment. In other embodiments, multiple orders can be placed at the same time, including orders having different sellers, delivery carriers and payment accounts. For example, a screen may show Order 1 and Order 2, each having different sellers, delivery carriers and payment information. Somewhere on the screen, a button, an icon or an option displays the option of “Place All Orders”. When this icon or option is selected, PS 110 may inquire, “Place Order 1 and Order 2”, and the buyer must select the “Yes” icon, button or option (or something similar) before both orders are submitted.

### RFP Search Example

In this example, a RFP bidder wants to see RFP bids in a 5 mile radius. The inputs to the search engine comprise (1) a project's physical address; (2) the address of the bidder; and (3) a defined radius. The project's physical address is stored when the information about the RFP was created by the RFP submitter, and is retrieved from memory associated with the information about the RFP. The address of the bidder is either entered during registration or manually entered (via an input from a screen, from a prompt or from CGV interaction). The defined radius is taken either from a setting during registration or from being selected or manually entered by a RFP bidder (via an input from a screen, from a prompt or from CGV interaction). The radius is preferably a geographical radius from the address of the bidder. In other embodiments, the “road” geographical radius could be used, where the distance is calculated from the address of the bidder and via distance of roads to the location of the RFP bid.

The category filter(s) may or may not be part of the process. Category filters are performed before the query, where project physical address(es) is returned and presented to a search engine (such as provided by Google) for geocoding. In one embodiment, the Google Maps Geocoding API provides a direct way to access these services via an HTTP request.

The search engine determines bids within a five mile radius by using geocoding. Geocoding is the process of converting addresses (like “1600 Amphitheatre Parkway, Mountain View, Calif.”) into geographic coordinates (like latitude 37.423021 and longitude −122.083739), which then can be used to place markers on a map, or a position the map.

The search engine takes the search inputs (physical addresses and defined radius) are executes a search in two parts. An initial native input prepares the search engine query by gathering procurements within selected categories via a simple database query. Location addresses within the selected category are then passed to the another search engine, such as Google API, for additional filtering based upon selected radius, using the bidders address as the pin point of the radius results. Geocoding of the radius area and geographic pin points are performed by the search engine. The results, including the map interface, are external content served through the search engine.

When the search enginer (or geocoder) returns results, it places them within a (JSON) results array. Even if the geocoder returns no results (such as if the address doesn't exist) it still returns an empty results array. (XML responses consist of zero or more <result> elements.) A typical result is made up of the following fields:
The types[ ] array indicates the type of the returned result. This array contains a set of zero or more tags identifying the type of feature returned in the result. For example, a geocode of “Chicago” returns “locality” which indicates that “Chicago” is a city, and also returns “political” which indicates it is a political entity.
formatted_address is a string containing the human-readable address of this location. Often this address is equivalent to the “postal address,” which sometimes differs from country to country. (Note that some countries, such as the United Kingdom, do not allow distribution of true postal addresses due to licensing restrictions.) This address is generally composed of one or more address components. For example, the address “111 8th Avenue, New York, N.Y.” contains separate address components for “111” (the street number, “8th Avenue” (the route), “New York” (the city) and “NY” (the US state). These address components contain additional information as noted below.
address components[ ] is an array containing the separate address components, as explained above. Each address_component typically contains:
   types[ ] is an array indicating the type of the address component.
   long_name is the full text description or name of the address component as returned by the Geocoder.
   short_name is an abbreviated textual name for the address component, if available. For example, an address component for the state of Alaska may have a long_name of “Alaska” and a short_name of “AK” using the 2-letter postal abbreviation.
Note that address_components[ ] may contain more address components than noted within the formatted_address.
postcode localities[ ] is an array denoting all the localities contained in a postal code. This is only present when the result is a postal code that contains multiple localities.
geometry contains the following information:
   location contains the geocoded latitude, longitude value. For normal address lookups, this field is typically the most important.
   location type stores additional data about the specified location. The following values are currently supported:
      “ROOFTOP” indicates that the returned result is a precise geocode for which we have location information accurate down to street address precision.
      “RANGE INTERPOLATED” indicates that the returned result reflects an approximation (usually on a road) interpolated between two precise points (such as intersections). Interpolated results are generally returned when rooftop geocodes are unavailable for a street address.
      “GEOMETRIC CENTER” indicates that the returned result is the geometric center of a result such as a polyline (for example, a street) or polygon (region).
      “APPROXIMATE” indicates that the returned result is approximate.
   viewport contains the recommended viewport for displaying the returned result, specified as two latitude, longitude values defining the southwest and northeast corner of the viewport bounding box. Generally the viewport is used to frame a result when displaying it to a user.
   bounds (optionally returned) stores the bounding box which can fully contain the returned result. Note that these bounds may not match the recommended viewport. (For example, San Francisco includes the Farallon islands, which are technically part of the city, but probably should not be returned in the viewport.)
   partial match indicates that the geocoder did not return an exact match for the original request, though it was able to match part of the requested address. The PS 110 may inquire about the original request for misspellings and/or an incomplete address. Partial matches most often occur for street addresses that do not exist within the locality you pass in the request. Partial matches may also be returned when a request matches two or more locations in the same locality. For example, “21 Henr St, Bristol, UK” will return a partial match for both Henry Street and Henrietta Street. Note that if a request includes a misspelled address component, the geocoding service may suggest an alternative address. Suggestions triggered in this way will also be marked as a partial match.
   place_id is a unique identifier that can be used with other Google APIs. For example, you can use the place_id in a Google Places API request to get details of a local business, such as phone number, opening hours, user reviews, and more.

PS 110 takes the output from the search engine, compiles the results and displays them on the RFP bidder's device. In one embodiment, results are generated and displayed via Google Maps Viewport. The “flags” or pins are located and displayed on a map using a display engine (e.g., Google API). The pins are based on inputs geocoded by the Google API. The following is a definition of those parameters accepted by the Google Geocoding API.

### Geocoding (Latitude/Longitude Lookup)

### Required Parameters in a Geocoding Request:

address—The street address is geocoded, in the format used by the national postal service of the country concerned. Additional address elements such as business names and unit, suite or floor numbers should be avoided. Please refer to the FAQ for additional guidance. or
components—A component filter which will obtain a geocode. The components filter will also be accepted as an optional parameter if an address is provided.
key—This key identifies your application for purposes of quota management.

Optional parameters in a geocoding request:
bounds—The bounding box of the viewport within which to bias geocode results more prominently. This parameter will only influence, not fully restrict, results from the geocoder.
language—The language in which to return results. See the list of supported domain languages. Note that we often update supported languages so this list may not be exhaustive. If language is not supplied, the geocoder will attempt to use the native language of the domain from which the request is sent wherever possible.
region—The region code, specified as a ccTLD (“top-level domain”) two-character value. This parameter will only influence, not fully restrict, results from the geocoder.
components—The component filters, separated by a pipe (|). Each component filter consists of a component: value pair and will fully restrict the results from the geocoder.

### Seller Inventory and Prices

Once a seller log-in in step 202 (FIG. 2A) and the system in step 204 (FIG. 2A) either queries what the seller wants to do, or by default or user customization, the seller is taken directly to the seller screens and prompts. The seller is provided a variety of different options including: (1) creating or updating its local storage of its inventory, prices and/or services; (2) creating or changing the Internet addresses or website links to network-accessible locations of storage the inventory (and prices) or services; (3) creating or changing security protocols related to the offsite addresses or links; (4) changing information related to the seller, e.g., address, zip, email contact(s), email contact(s), RFP contact(s) information, phone numbers; (5) selecting or changing the categories (e.g., restaurant, clothes, home goods, furniture, electronics, art galleries, gas stations, etc.) related to the seller's goods, products and/or services; (6) selecting or changing delivery options related to the goods or services; (7) selecting or specifying the type of seller, whether national, regional, or local). The seller can navigate to and select these different options using icons, button, or other ways known now (or in the future) to those skilled in the art. The present invention also includes other types and different options in addition to those options described herein.

PS 110 creates, updates and maintains a master list of sellers. The master seller list is used to find sellers who match the criteria of each user's order. As described above, users select the sellers based on many different criteria, including distance from the user's location, for example. The master list is assembled (1) from sellers who create an account in PS 110 (via the website), by providing the seller information described above; and (2) from sellers who upload their inventory to reside locally at PS 110 (or one of its databases or other memory or storage). Periodically at some interval of time (e.g., weekly, monthly, semi-annually), PS 110 also uses the GCS API (or other similar search engines) to search (usually during off-peak hours, e.g., 12 midnight to 6 am) for new sellers based on a zip code. For example, for the 92651 (Laguna Beach) zipcode, PS 110 searches the Internet for businesses located within the 92651 zip code. The search engine searches for business names, and what goods or services each of the business offers, whether there is a website associated with the seller, the type of website (regular or e-commerce) and contact information. PS 110 assembles the information about the businesses into a database, where the businesses are stored or referred by its specific location (e.g., a zip code, a city, a county, a state, a region, etc.). The database entry will also contain information about the website and whether the website is searchable. This information can be used by PS 110 to automatically contact the business and offer them the opportunity to become a seller on the website associated with PS 110. Whether the seller uploads its inventory including its prices to a storage device connected to PS 110 locally, or maintains remotely its own inventory and/or website, PS 110 provides formats, goods/services descriptions and standardization information to help the seller standardize its information so that the goods and services offered by a seller are easier to search. By standardizing across different categories of goods and services, the local businesses or sellers will have a greater presence on the Internet, having a database or website that is easier for search engines such as GCS API to locate and find the correct information about a business.

Although any seller can receive RFPs as described herein according to their contact information (e.g., email, text, Facebook, Twitter, etc.), it is preferred that the seller first register and open an account before being able to receive RFPs. PS 110 will recommend to the seller that the seller provide a special notification account (e.g., email, text, Facebook, Twitter) that will specially receive RFPs and thereafter, will promptly notify the people responsible for monitoring RFPs that an RFP has been received. RFPs are usually time-sensitive, so having a special account to deal with RFPs is preferred but not mandatory. Moreover, PS 110 needs assurance that a bid received in response to a RFP is authorized by or on behalf of the seller. This will help to prevent fraud and unauthorized bids from the seller.

Returning to FIG. 2A, if a buyer wants to view and/or change orders in response to the query of what the user wants to do in step 204 (FIG. 2A), PS 110 provides the buyer with screens and prompts about the past orders including for example: (1) viewing past orders and their corresponding status (e.g., pending, in transit, delivered, cancelled, etc); (2) checking on the location of where the order is in transit; (3) canceling an order; and (4) changing an order. Sometimes it is possible to change an order in some circumstances, such as when the order is pending and has not shipped from the seller. In some embodiments, this can occur any time after the order is placed and before until the order is processed and assembled for delivery (or for pick-up). In such situations, the user has the option of changing the order, including for example, cancelling the order in whole, deleting items or services from the order, adding new items or services to the order, subdividing an order into multiple orders, merging multiple orders into a single order, changing sellers for an order, changing deliver preferences for an order, and changing payment information for an order. The present invention is not necessarily limited to these order options, as these are just example. Other options are possible to those described herein.

In FIG. 2A, if the user wants to view and/or change the account information in response to the query of what the user wants to do in step 204 (FIG. 2A), PS 110 provides the user with screens and prompts about the account information. The user can view and change payment information, delivery addresses, contact information (e.g., email, phone numbers, etc) and any other information associated with the user as being a buyer or seller. These preferences can be made available to the user in other screens as drop-down menus, where for example, the user will be able to chose from different credit cards or bank accounts.

### Request for Proposal

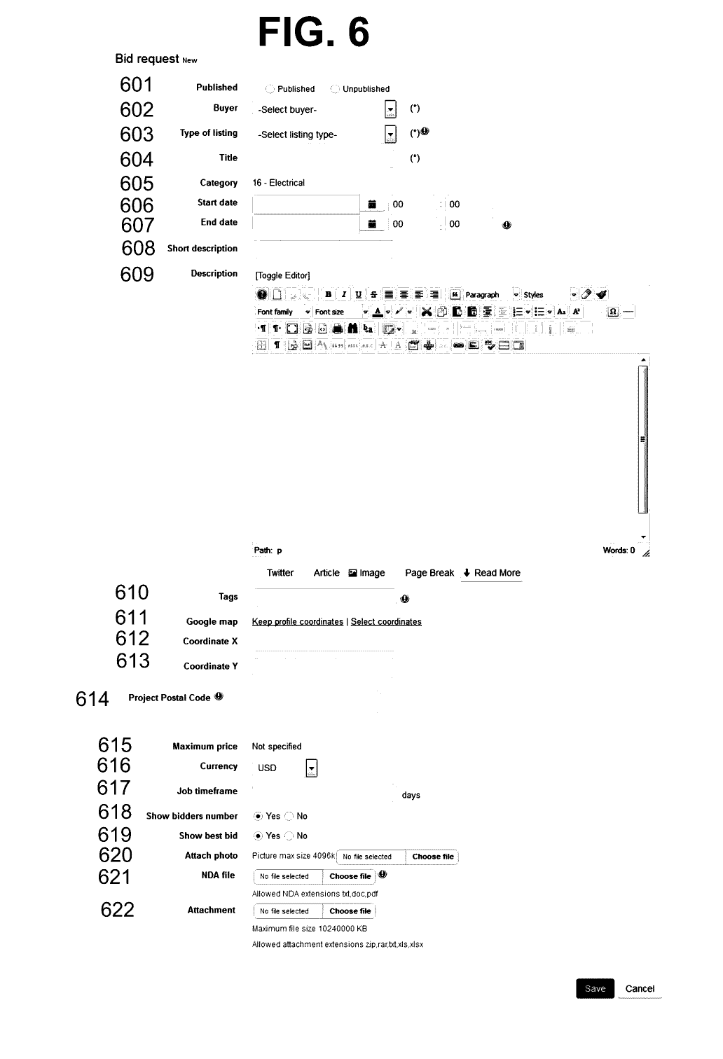

FIG. 6 shows information collected by PS 110 for a new request for a proposal (RFP) according to an embodiment of the present invention. This information may be displayed to the RFP submitter in response to the questions or prompts presented in step 204 (FIG. 2A) or directly after log-in. The RFP submitter has the option of selecting whether the RFP will be published 601 by selecting either the “published” button or the “unpublished” button. A published RFP will be published or made available on the Internet via PS 110 to interested companies and individuals. The name of the RFP submitter is entered in 602.

The RFP submitter selects the “type of listing” in 603, where the selections include “public”, “private” and “invite”. “Public” means that any company and individual can participate in bidding on the RFP. “Private” means that one or more groups of selected companies and individuals can participate in bidding on the RFP, and “Invite” means that only specific companies and individuals selected by the RFP submitter can participate in bidding on the RFP. The “title” 604 of the RFP specifies the type of goods, materials or services are being requested. In FIG. 6, this example shows “Materials for wiring 4 homes”. In field 605, the category of the RFP is specified, either from a pull-down menu (as illustrated in FIG. 6), or as a fill-in box. The category represents an area of a particular field, in FIG. 6, “16—electrical”. In other embodiments, a “type” of area may be selected first, followed by a “category”. For example, the “type” may be for example, construction, home goods, automobile, restaurant. The categories under “construction” may include general, site construction, concrete, masonry, metals, wood and plastics, thermal & moisture protection, doors and windows, finishes and specialties.

The RFP submitter selects the “start date” 606 and “end date” 607 including the day, hour and minutes. A short description of the RFP can be provided in 608, a longer description can be provided in 609, and the “tags” can be provided in 610. Each of the fields 608-610 can be searched by bidders for bidding on specific types of RFPs.

Fields 611 is a “map” field where the work is going to be performed or goods or services delivered. If “select coordinates” is selected, a pop-up window is provided with a map, where the user can zoom-in and zoom-out of the map, locating precisely the longitudinal and latitude coordinates of where the work will be performed, or the goods or services are to be delivered. A “pin” is placed on the map associated with the new RFP listing. When bidders are searching for RFPs in a specific geographical area, these “pins” are shown on a map. Once the “pin” is placed on the map, the X coordinate 612, the Y coordinate 613 and the zipcode 614 are automatically filled-in with the specific coordinates and proper zipcode.

A maximum price 615 can be specified for the RFP, the currency 616 (e.g., US dollars), and the time frame 617 for completing a job. For example, the RFP specifies the time frame of “12 days” for installing the wiring for four homes. The bidder number 618 can be selected for display as well as the best bid 619. This information will help the RFP submitter know more information about the bidders and who the best bidder is at any moment during the open RFP.

The RFP submitter can attach photographs 620, a non-disclosure agreement 621 and other relevant documents 622 using the latest methodologies such as browse/attach. The example shown in FIG. 6 is a representative example, but there may be more fields (or less fields) that can be used for each RFP. For example, there may be a field for when the RFP submitter intends to select a bid to fulfill the RFP, this field being in hours or days from the when the bidding closes.

PS 110 stores a variety of templates of RFPs for certain types of goods or services which the RFP submitter can select. For example, the RFP submitter may say “RFP construction”, which displays a RFP specific to construction or building, such as illustrated in FIG. 6. In another example, the RFP submitter may say “RFP venue”, “RFP cater” or “RFP wedding cake” which displays separate RFP templates for obtaining a wedding venue, obtaining a cater for a wedding and for obtaining a wedding cake, each RFP displayed in tabular form, one on top of each other. PS 110 stores different RFP templates in a database that can be referenced by any RFP submitter. By having standard RFP templates for different industries, it will help the RFP submitter address specific issues relating to that industry and not miss critical deal points. This will provide a standardization of particular industries and help to make a new paradigm shift for establishing minimum terms and conditions for different types of RFPs.

Once the required fields are filled-in, the RFP submitter clicks “Post” button, whereupon PS 110 will take the listing and assign a unique RFP number to the listing. PS 110 will store the new RFP listing in one or more databases, including the database associated with a particular geographical region of where the RFP is located for the job or delivery of goods or services. If the RFP is a “public” listing, PS 110 will display it on the dashboard of the relevant type and category. If the RFP is a “private” or “invite” listing, PS 110 will send the RFP to the select group for a private listing, or select individuals for an “invite” listing. PS 110 will manage the display of the RFP and the receipt of bids per RFP. The RFP will remain “open” during the bidding and then “closed” once the interval or period of time for accepting bids has terminated. The designation “Accepted” means that a particular bidder was selected by the RFP submitter to fulfill the RFP, while “Passed” means that the particular bidder was not selected. The RFP submitter will only tell PS 110 to designate the other bids as “Passed” after a period of time has elapsed or once the accepted bidder has been confirmed by the RFP submitter.

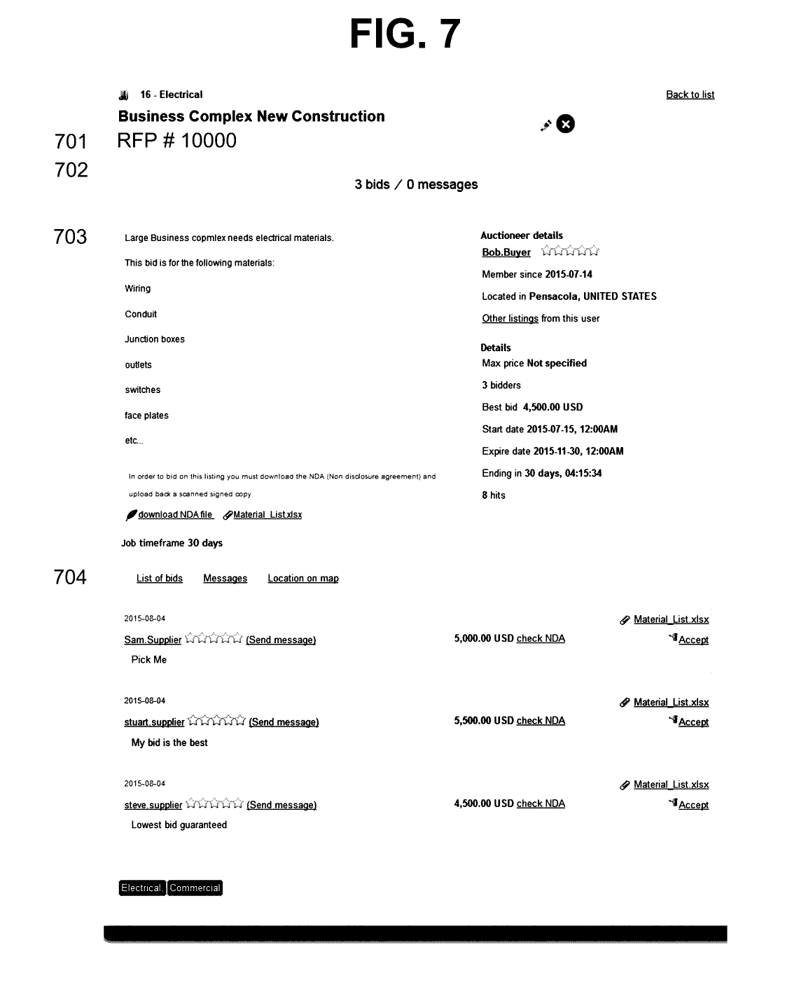

FIG. 7 shows an example of a screen display of bids associated with an RFP according to an embodiment of the present invention. The list of bids for a particular RFP is displayed by PS 110 to the user who submitted the RFP listing. The RFP number 701 assigned by PS 110 is shown in at the top. The number of bids and number of messages are displayed in a box 702. The details about the RFP are shown in 703. This information may be encapsulated into a box form, where the box can be minimized or expanded, whatever the RFP submitter prefers. The dashboard 704 is able to lists the RFP bids in any order selected by the RFP submitter, including best bid, star rating of bidder, and other details that helps the RFP submitter select the best bid from the bids.

A bidder can search the RFP listings via keywords, categories, time intervals, price ranges or other selectable criteria. The number and order of the RFP listings can be displayed according to bidder preference, meaning the listings can be sorted and displayed by location, name, type of work, estimated number of days to complete the project, etc. A geographical search can be performed on the RFP listings, where an address or zip code is entered, and a radius (of a circle) is specified in miles or kilometers from the center of the circle.

“Reciprocal Search Protocol” (RSP) is the ability of the sellers or vendors to identify what bid item are requested in real-time, and the ability to insert their cost(s) in real-time. Sellers or vendors are notified by their chosen method to the device or devices (e.g., smart-phone, tablet or computer) according to their preferences, whether via email, text, or another real-time application, each having customizable sounds or vibrations attached thereto. The sellers and vendors are notified immediately (or substantially in real-time) when a request (including RFP's) for a price of an item(s) or service(s) has been received. The seller and vendor can type in their price and other pertinent information (e.g., discounts, delivery times, shipping information, whether item is in-stock, etc.) which is immediately (or substantially in real-time) relayed to the user or buyer. This system and method allows the user or buyer to know within a short period of time whether a seller or vendor can fulfill the order, thus making a user more readily able to make the purchase and satisfied.

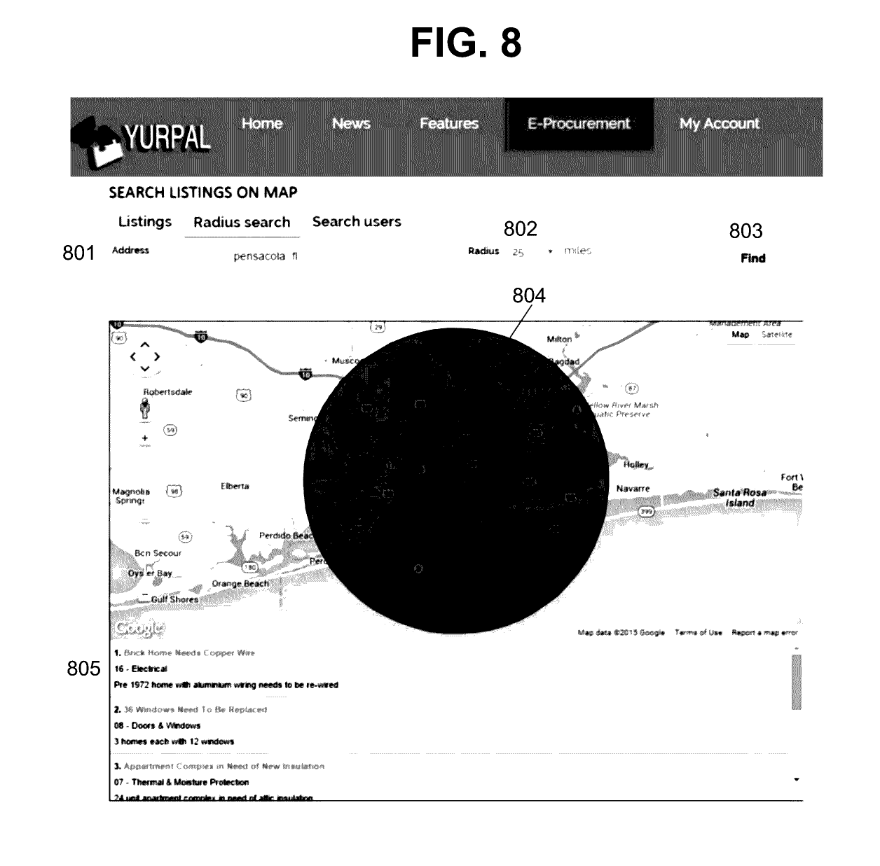

FIG. 8 shows an example of a geographical screen display associated with open RFPs according to an embodiment of the present invention. In this example, the map shows open RFP bids in the Pensacola, Fla. area. The map is displayed according to an address 801 and a radius 802. A user can fill-in a particular address, city, state and/or zip code into the address box 801. The radius box 802 is a pull-down menu where different increments in miles or kilometers can be selected. When a city/state or zipcode are selected, the map will choose a central location within that particular city/state or zipcode. After the user selects the “Find” 803 button, the screen will display a geographical map with a circle as shown in FIG. 8. The center point of the circle is located at the address or a center point of the city/state or zipcode. The circle may be a different color, such as red (not shown). Within the radius of the circle, there are five “pins”, each “pin” representing an open RFP where a company or person can bid on the open RFP. Each “pin” can also be a different color, where each color can represent a different category in variety of different RFPs (e.g., electrical versus doors/windows or thermal protection). Corresponding to each “pin” as displayed on the map, is a brief listing of the details of each RFP. The user can either select the “pin” and the corresponding RFP listing will be displayed below the map or as a pop-up, or the user can select a particular RFP listing and the corresponding “pin” on the map will be enlarged, change color or shown according to a user's preference.

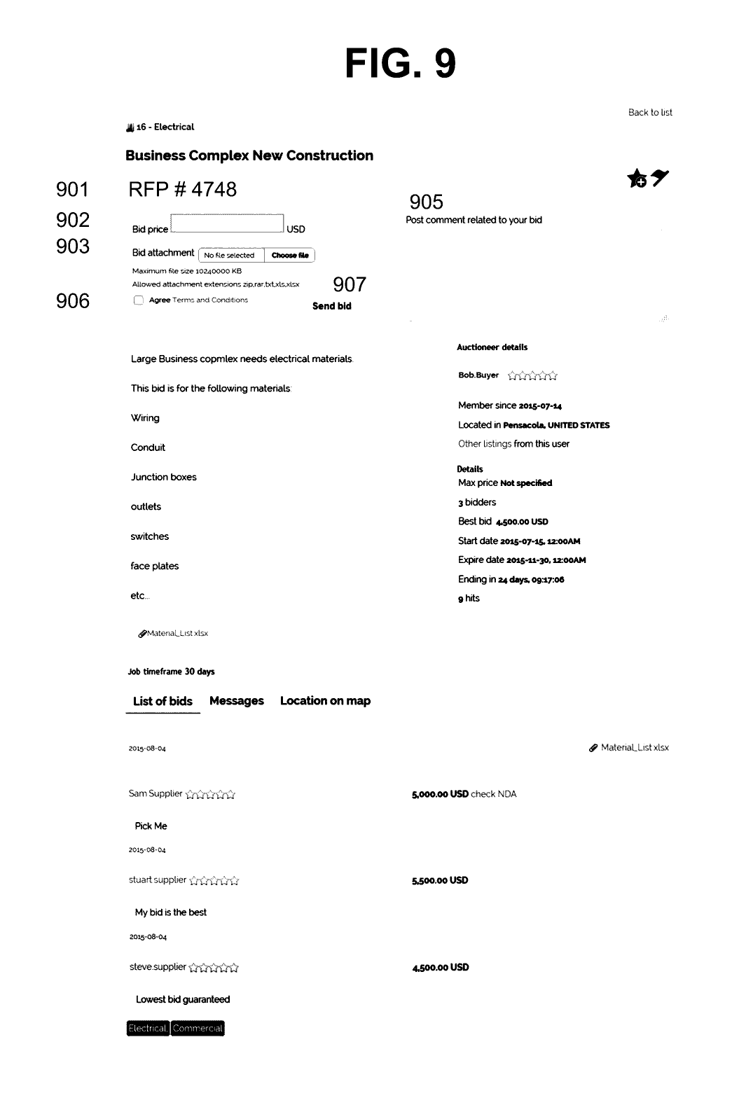

Once a RFP is located, a bidder may be shown a screen such as shown in FIG. 9. FIG. 9 shows an example of a screen display for bidding on an open RFP according to an embodiment of the present invention. The RFP number is shown in area 801, and may include the title of the RFP and the location. Alternatively, the RFP box 901 may be a box that is expanded or minimized as desired by the bidder. The bidder enters the bid price 902 and selects the currency (e.g., US dollars). An executed non-disclosure agreement 903 can be uploaded to the PS 110 as well as any attachments 904. The bidder can post special comments to the RFP submitter in box 905. These comments will only be seen by the RFP submitter and not the other bidders. PS 110 will require that the bidder agree to specific terms and conditions by checking the box 906. These terms and conditions can be viewed by clicking on the terms and conditions link, where they are shown in a pop-up screen, on a separate tab or in a new window. Once all required bidding information is entered, the bidder clicks on “send bid” 907 which then sends the bid to PS 110 where it is associated with the particular RFP number.

It should be apparent to one skilled in the art that the methods and systems of the present invention can be implemented on a variety of devices and systems. While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A computer-implemented method for procuring items in an order from a user, comprising:
receiving one or more items in a first order;
searching for one or more sellers who are able to supply one or more of the items in the first order;
assembling information about each of the sellers who are able to supply one or more of the items in the first order; and
sending the assembled information about the sellers to the user, where the assembled information is displayed on a device associated with the user.

2. The method as in claim 1, further comprising:
receiving a second order from the user; and
displaying on the device the first order on top of the second order or next to the second order.

3. The method as in claim 2, wherein an item displayed on the first order can be moved to the second order, the item being identified by a name, the item being moved via dragging the name from the first order to the second order or cutting the name from the first order and pasting into the second order.

4. The method as in claim 2, wherein an item displayed on the first order can be moved to the second order, the item being identified by a name, further comprising:
receiving a command from the user about moving an item from one order to another order; and
moving the item from the first order to the second order wherein the item is displayed on the second order.

5. The method as in claim 1, further comprising:
for each of the items, finding a common indication, the common indication being a UPC symbol or model number.

6. The method as in claim 5, wherein the searching comprises searching resources associated with each of the one or more sellers for availability of each item on an order, the searching using the common indication of each item.

7. The method as in claim 6, wherein the resources include a database of items for each of the one or more sellers.

8. The method as in claim 6, further comprising:
when one or more items are not found in the database of times for a particular seller, searching a website or on-line resource associated with the particular seller for the one or more items that are not found in the resources associated with the particular seller.

9. The method as in claim 1, wherein the information includes whether a seller has a particular item in stock.

10. The method as in claim 1, further comprising:
receiving one or more selections of the one or more sellers who are able to supply one or more of the items in the first order;
receiving an indication to place the order;
debiting an account with the user for a total amount of the first order; and
sending a corresponding part of the order to selected sellers.

11. A system for procuring items in an order from a user, comprising:
a customer order engine that receives one or more items in a first order from the user;
a search engine connected to the customer engine that searches for one or more sellers who are able to supply one or more of the items in the first order;
an assembling engine connected to the search engine that assembles information about each of the sellers who are able to supply one or more of the items in the first order; and
the customer order engine connected to the assembling engine that sends the assembled information about the sellers to the user, where the assembled information is displayed on a device associated with the user.

12. The system as in claim 11, wherein the customer order engine receives a second order from the user, and displays on the device the first order on top of the second order or next to the second order.

13. The system as in claim 12, wherein the customer order engine receives a command from the user about moving an item from one order to another order; and
the customer order engine moves the item from the first order to the second order wherein the item is displayed on the second order.

14. The system as in claim 11, wherein the customer order engine identifies a common indication for each of the items on the first list, the common indication being a UPC symbol or model number.

15. The system as in claim 11, wherein the search engine further comprises searching databases associated with each of the one or more sellers for availability of each item on an order.

16. The system as in claim 6, wherein the search engine further comprises:
when one or more items are not found in the database of times for a particular seller, searching a website or on-line resource associated with the particular seller for the one or more items that are not found in the resources associated with the particular seller.

17. The system as in claim 11, wherein the information includes whether a seller has a particular item in stock.

18. The system as in claim 11, wherein the customer order engine receives an indication for placing the first order; and further comprising:
customer account engine connected to the customer order engine where an an account associated with the user is debited for a total amount of the first order; and
seller order engine that sends a corresponding part of the order to selected sellers.
